(19) United States
(12) Patent Application Publication
(10) Pub. No.: US 2024/0018863 A1
(43) Pub. Date: Jan. 18, 2024

(54) FIELD EQUIPMENT SYSTEM

(71) Applicant: Schlumberger Technology Corporation, Sugar Land, TX (US)

(72) Inventors: Amey Ambade, Houston, TX (US); Sreekrishnan Ramachandran, Houston, TX (US); Piyush Umate, Houston, TX (US); Supriya Gupta, Houston, TX (US)

(21) Appl. No.: 18/353,198

(22) Filed: Jul. 17, 2023

Related U.S. Application Data
(60) Provisional application No. 63/389,627, filed on Jul. 15, 2022.

(51) Int. Cl. E21B 44/00; E21B 47/002

(52) U.S. Cl. CPC E21B 44/00; E21B 47/0025; E21B 2200/22

(57) ABSTRACT

A method can include receiving results from a field device at a field site, where the results are generated using a trained machine learning model at the field site and real-time field equipment data from field equipment at the field site; issuing a signal responsive to an assessment of the results, where the signal indicates a performance-related issue of the trained machine learning model; updating training data with at least a portion of the real-time field equipment data to address the performance-related issue; and generating a new trained machine learning model for deployment to the field site using at least a portion of the updated training data.

### RELATED APPLICATION

This application claims priority to and the benefit of a US Provisional application having Ser. No. 63/389,627, filed 15 Jul. 2022, which is incorporated herein by reference in its entirety.

### BACKGROUND

A reservoir can be a subsurface formation that can be characterized at least in part by its porosity and fluid permeability. As an example, a reservoir may be part of a basin such as a sedimentary basin. A basin can be a depression (e.g., caused by plate tectonic activity, subsidence, etc.) in which sediments accumulate. As an example, where hydrocarbon source rocks occur in combination with appropriate depth and duration of burial, a petroleum system may develop within a basin, which may form a reservoir that includes hydrocarbon fluids (e.g., oil, gas, etc.). Various operations may be performed in the field to access such hydrocarbon fluids and/or produce such hydrocarbon fluids. For example, consider equipment operations where equipment may be controlled to perform one or more operations.

### SUMMARY

A method can include receiving results from a field device at a field site, where the results are generated using a trained machine learning model at the field site and real-time field equipment data from field equipment at the field site; issuing a signal responsive to an assessment of the results, where the signal indicates a performance-related issue of the trained machine learning model; updating training data with at least a portion of the real-time field equipment data to address the performance-related issue; and generating a new trained machine learning model for deployment to the field site using at least a portion of the updated training data. A system can include a processor; memory accessible to the processor; and processor-executable instructions stored in the memory to instruct the system to: receive results from a field device at a field site, where the results are generated using a trained machine learning model at the field site and real-time field equipment data from field equipment at the field site; issue a signal responsive to an assessment of the results, where the signal indicates a performance-related issue of the trained machine learning model; update training data with at least a portion of the real-time field equipment data to address the performance-related issue; and generate a new trained machine learning model for deployment to the field site using at least a portion of the updated training data. One or more computer-readable storage media can include processor-executable instructions to instruct a computing system to: receive results from a field device at a field site, where the results are generated using a trained machine learning model at the field site and real-time field equipment data from field equipment at the field site; issue a signal responsive to an assessment of the results, where the signal indicates a performance-related issue of the trained machine learning model; update training data with at least a portion of the real-time field equipment data to address the performance-related issue; and generate a new trained machine learning model for deployment to the field site using at least a portion of the updated training data. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example system that includes various framework components associated with one or more geologic environments;

FIG. 2 illustrates examples of equipment, an example of a network and an example of a system;

FIG. 3 illustrates example of equipment;

FIG. 4 illustrates an example of pump equipment;

FIG. 5 illustrates an example of a system;

FIG. 6 illustrates an example of a method;

FIG. 7 illustrates an example of a system;

FIG. 8 illustrates an example of a system and a graphical user interface of locations of field equipment;

FIG. 9 illustrates an example of a system;

FIG. 10 illustrates an example of a method and an example of a system;

FIG. 11 illustrates an example of a method;

FIG. 12 illustrates an example of a method;

FIG. 13 illustrates examples of computer and network equipment; and

FIG. 14 illustrates example components of a system and a networked system.

### DETAILED DESCRIPTION

This description is not to be taken in a limiting sense, but rather is made merely for the purpose of describing the general principles of the implementations. The scope of the described implementations should be ascertained with reference to the issued claims.

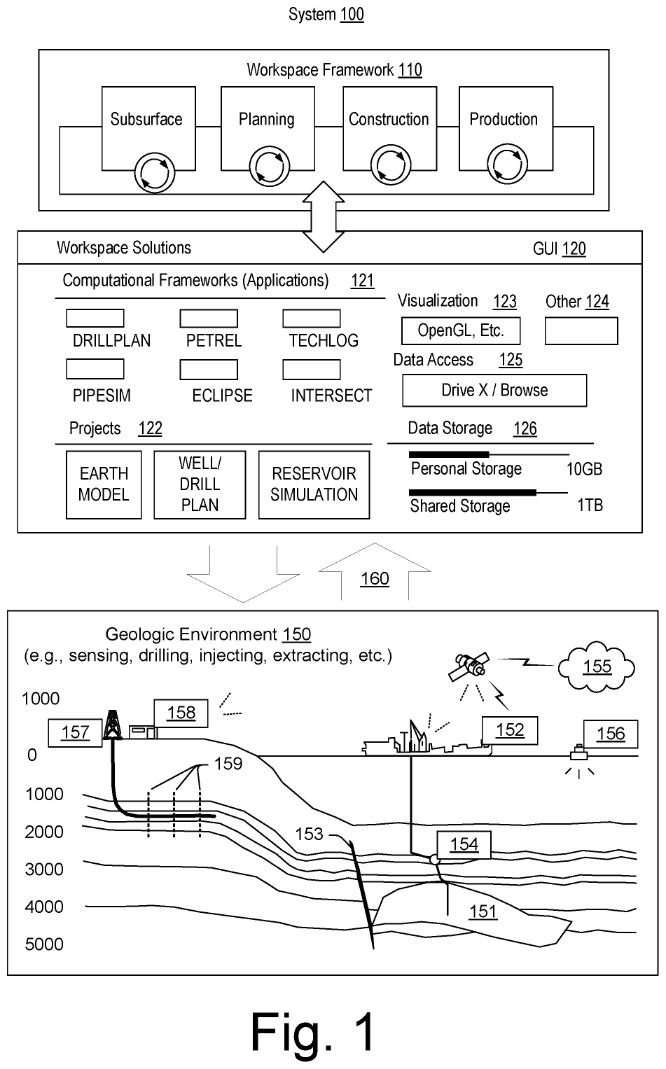

FIG. 1 shows an example of a system 100 that includes a workspace framework 110 that can provide for instantiation of, rendering of, interactions with, etc., a graphical user interface (GUI) 120. In the example of FIG. 1, the GUI 120 can include graphical controls for computational frameworks (e.g., applications) 121, projects 122, visualization 123, one or more other features 124, data access 125, and data storage 126.

In the example of FIG. 1, the workspace framework 110 may be tailored to a particular geologic environment such as an example geologic environment 150. For example, the geologic environment 150 may include layers (e.g., stratification) that include a reservoir 151 and that may be intersected by a fault 153. As an example, the geologic environment 150 may be outfitted with a variety of sensors, detectors, predictors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a wellsite and include sensing, detecting, predicting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

In the example of FIG. 1, the GUI 120 shows some examples of computational frameworks, including the DRILLPLAN, PETREL, TECHLOG, PETROMOD, ECLIPSE, and INTERSECT frameworks (SLB, Houston, Texas).

The DRILLPLAN framework provides for digital well construction planning and includes features for automation of repetitive tasks and validation workflows, enabling improved quality drilling programs (e.g., digital drilling plans, etc.) to be produced quickly with assured coherency.

The PETREL framework can be part of the DELFI cognitive exploration and production (E&P) environment (SLB, Houston, Texas, referred to as the DELFI environment) for utilization in geosciences and geoengineering, for example, to analyze subsurface data from exploration to production of fluid from a reservoir.

One or more types of frameworks may be implemented within or in a manner operatively coupled to the DELFI environment, which is a secure, cognitive, cloud-based collaborative environment that integrates data and workflows with digital technologies, such as artificial intelligence (AI) and machine learning (ML). As an example, such an environment can provide for operations that involve one or more frameworks. The DELFI environment may be referred to as the DELFI framework, which may be a framework of frameworks. As an example, the DELFI environment can include various other frameworks, which can include, for example, one or more types of models (e.g., simulation models, etc.).

The TECHLOG framework can handle and process field and laboratory data for a variety of geologic environments (e.g., deepwater exploration, shale, etc.). The TECHLOG framework can structure wellbore data for analyses, planning, etc.

The PIPESIM simulator includes solvers that may provide simulation results such as, for example, multiphase flow results (e.g., from a reservoir to a wellhead and beyond, etc.), flowline and surface facility performance, etc. The PIPESIM simulator may be integrated, for example, with the AVOCET production operations framework (SLB, Houston Texas). As an example, a reservoir or reservoirs may be simulated with respect to one or more enhanced recovery techniques (e.g., consider a thermal process such as steam-assisted gravity drainage (SAGD), etc.). As an example, the PIPESIM simulator may be an optimizer that can optimize one or more operational scenarios at least in part via simulation of physical phenomena.

The ECLIPSE framework provides a reservoir simulator (e.g., as a computational framework) with numerical solutions for fast and accurate prediction of dynamic behavior for various types of reservoirs and development schemes.

The INTERSECT framework provides a high-resolution reservoir simulator for simulation of detailed geological features and quantification of uncertainties, for example, by creating accurate production scenarios and, with the integration of precise models of the surface facilities and field operations, the INTERSECT framework can produce reliable results, which may be continuously updated by real-time data exchanges (e.g., from one or more types of data acquisition equipment in the field that can acquire data during one or more types of field operations, etc.). The INTERSECT framework can provide completion configurations for complex wells where such configurations can be built in the field, can provide detailed chemical-enhanced-oil-recovery (EOR) formulations where such formulations can be implemented in the field, can analyze application of steam injection and other thermal EOR techniques for implementation in the field, advanced production controls in terms of reservoir coupling and flexible field management, and flexibility to script customized solutions for improved modeling and field management control. The INTERSECT framework, as with the other example frameworks, may be utilized as part of the DELFI cognitive E&P environment, for example, for rapid simulation of multiple concurrent cases. For example, a workflow may utilize one or more of the DELFI on demand reservoir simulation features.

The aforementioned DELFI environment provides various features for workflows as to subsurface analysis, planning, construction and production, for example, as illustrated in the workspace framework 110. As shown in FIG. 1, outputs from the workspace framework 110 can be utilized for directing, controlling, etc., one or more processes in the geologic environment 150 and, feedback 160, can be received via one or more interfaces in one or more forms (e.g., acquired data as to operational conditions, equipment conditions, environment conditions, etc.).

As an example, a workflow may progress to a geology and geophysics (“G&G”) service provider, which may generate a well trajectory, which may involve execution of one or more G&G software packages.

In the example of FIG. 1, the visualization features 123 may be implemented via the workspace framework 110, for example, to perform tasks as associated with one or more of subsurface regions, planning operations, constructing wells and/or surface fluid networks, and producing from a reservoir.

As an example, a visualization process can implement one or more of various features that can be suitable for one or more web applications. For example, a template may involve use of the JAVASCRIPT object notation format (JSON) and/or one or more other languages/formats. As an example, a framework may include one or more converters. For example, consider a JSON to PYTHON converter and/or a PYTHON to JSON converter. In such an approach, one or more features of a framework that may be available in one language may be accessed via a converter. For example, consider the APACHE SPARK framework that can include features available in a particular language where a converter may convert code in another language to that particular language such that one or more of the features can be utilized. The APACHE SPARK framework also provides an analytics engine for large-scale data processing along with an interface for programming clusters with implicit data parallelism and fault tolerance. As an example, a production field may include various types of equipment, be operable with various frameworks, etc., where one or more languages may be utilized. In such an example, a converter may provide for feature flexibility and/or compatibility.

As an example, visualization features can provide for visualization of various earth models, properties, etc., in one or more dimensions. As an example, visualization features can provide for rendering of information in multiple dimensions, which may optionally include multiple resolution rendering. In such an example, information being rendered may be associated with one or more frameworks and/or one or more data stores. As an example, visualization features may include one or more control features for control of equipment, which can include, for example, field equipment that can perform one or more field operations. As an example, a workflow may utilize one or more frameworks to generate information that can be utilized to control one or more types of field equipment (e.g., drilling equipment, wireline equipment, fracturing equipment, etc.).

While several simulators are illustrated in the example of FIG. 1, one or more other simulators may be utilized, additionally or alternatively. For example, consider the VISAGE geomechanics simulator (SLB, Houston Texas) or the PETROMOD simulator (SLB, Houston Texas), etc. The VISAGE simulator includes finite element numerical solvers that may provide simulation results such as, for example, results as to compaction and subsidence of a geologic environment, well and completion integrity in a geologic environment, cap-rock and fault-seal integrity in a geologic environment, fracture behavior in a geologic environment, thermal recovery in a geologic environment, CO₂ disposal, etc. The PETROMOD framework provides petroleum systems modeling capabilities that can combine one or more of seismic, well, and geological information to model the evolution of a sedimentary basin. The PETROMOD framework can predict if, and how, a reservoir has been charged with hydrocarbons, including the source and timing of hydrocarbon generation, migration routes, quantities, and hydrocarbon type in the subsurface or at surface conditions. The MANGROVE simulator (SLB, Houston, Texas) provides for optimization of stimulation design (e.g., stimulation treatment operations such as hydraulic fracturing) in a reservoir-centric environment. The MANGROVE framework can combine scientific and experimental work to predict geomechanical propagation of hydraulic fractures, reactivation of natural fractures, etc., along with production forecasts within 3D reservoir models (e.g., production from a drainage area of a reservoir where fluid moves via one or more types of fractures to a well and/or from a well). The MANGROVE framework can provide results pertaining to heterogeneous interactions between hydraulic and natural fracture networks, which may assist with optimization of the number and location of fracture treatment stages (e.g., stimulation treatment(s)), for example, to increased perforation efficiency and recovery.

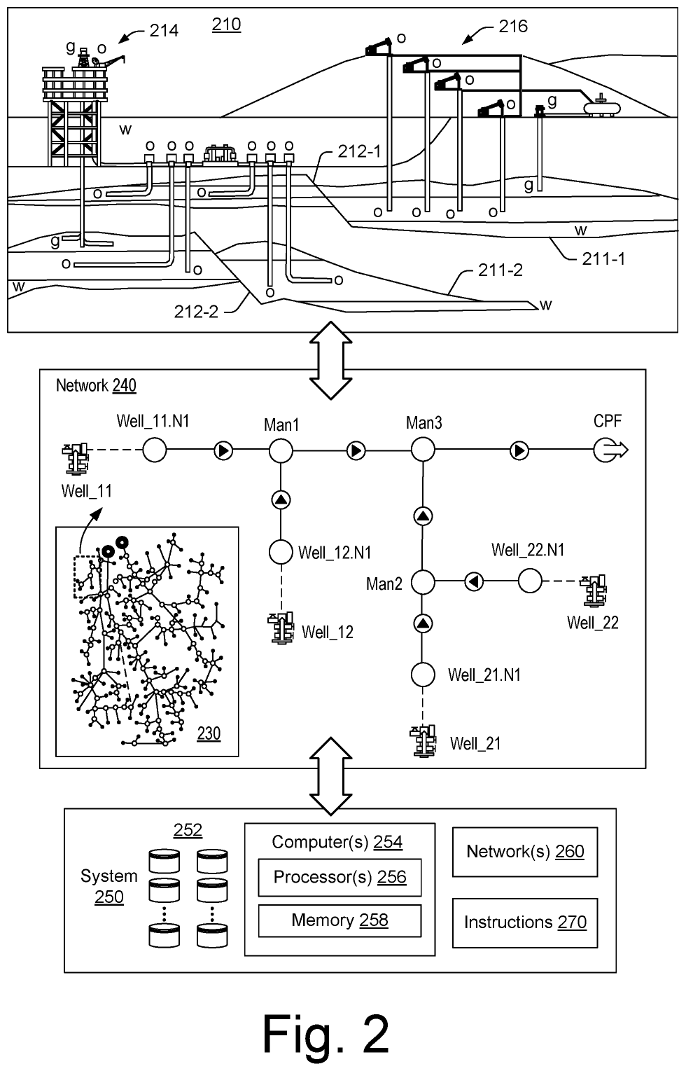

FIG. 2 shows an example of a geologic environment 210 that includes reservoirs 211-1 and 211-2, which may be faulted by faults 212-1 and 212-2, an example of a network of equipment 230, an enlarged view of a portion of the network of equipment 230, referred to as network 240, and an example of a system 250. FIG. 2 shows some examples of offshore equipment 214 for oil and gas operations related to the reservoir 211-2 and onshore equipment 216 for oil and gas operations related to the reservoir 211-1. In the example of FIG. 2, the geologic environment 210 can include fluids such as oil (o), water (w) and gas (g), which may be stratified in the reservoirs 211-1 and 211-2.

In the example of FIG. 2, the equipment 214 and 216 can include one or more of drilling equipment, wireline equipment, production equipment, etc. For example, consider the equipment 214 as including a drilling rig that can drill into a formation to reach a reservoir target where a well can be completed for production of hydrocarbons. As an example, the equipment 216 can include production equipment such as wellheads, valves, pump equipment, gas handling equipment, etc. As an example, one or more features of the system 100 of FIG. 1 may be utilized for operations in the geologic environment 210. For example, consider utilizing a drilling or well plan framework, a drilling execution framework, a production framework, etc., to plan, execute, etc., one or more drilling operations, production operations, etc.

In FIG. 2, the network 240 can be an example of a relatively small production system network. As shown, the network 240 forms somewhat of a tree like structure where flowlines represent branches (e.g., segments) and junctions represent nodes. As shown in FIG. 2, the network 240 provides for transportation of fluid (e.g., oil, water and/or gas) from well locations along flowlines interconnected at junctions with final delivery at a central processing facility (CPF). Where fluid includes solids (e.g., sand, etc.), one or more pieces of equipment may provide for solids removal, collection, etc. The network 240 can include various types of equipment, including surface and/or downhole equipment. Equipment may include powered equipment, which may be powered using one or more power sources. For example, consider electrical power from sources such as a power grid, solar, wind, fuel generator (e.g., gas turbine generator, combustion engine generator, etc.), etc., and/or power from mechanical, hydraulic, etc., sources. As mentioned, equipment can include fluid handling equipment, which can include pumps, which may be driven by one or more power sources. A pump may be a surface pump, a downhole pump, part of a system with surface components and downhole components. As an example, a pump may be a compressor. A compressor can be equipment that can raise pressure of fluid (e.g., air, natural gas, etc.). As an example, a compressor may utilize a positive displacement mechanism to compress fluid to higher pressures so that the fluid can flow via one or more pipelines, etc.

In the example of FIG. 2, various portions of the network 240 may include conduit, which may be in the form of one or more pipelines. For example, consider two conduits which may be a conduit to Man1 and a conduit to Man3 in the network 240, where Man1, Man2 and Man3 are manifolds. In the example of FIG. 2, the manifolds provide for flow of fluid from the various wells (Well_11, Well_12, Well_21 and Well_22) to the CPF. Fluid may be single phase and/or multiphase. The network 240 can include one or more pumps, which may be suitable for single phase fluid and/or multiphase fluid.

As shown in FIG. 2, the example system 250 includes one or more information storage devices 252, one or more computers 254, one or more networks 260 and instructions 270 (e.g., organized as one or more sets of instructions). As to the one or more computers 254, each computer may include one or more processors (e.g., or processing cores) 256 and memory 258 for storing the instructions 270 (e.g., one or more sets of instructions), for example, executable by at least one of the one or more processors. As an example, a computer may include one or more network interfaces (e.g., wired or wireless), one or more graphics cards, a display interface (e.g., wired or wireless), etc. As an example, imagery such as surface imagery (e.g., satellite, geological, geophysical, etc.) may be stored, processed, communicated, etc. As an example, data may include SAR data, GPS data, etc. and may be stored, for example, in one or more of the storage devices 252. As an example, information that may be stored in one or more of the storage devices 252 may include information about equipment, location of equipment, orientation of equipment, fluid characteristics, etc.

As an example, the instructions 270 can include instructions (e.g., stored in the memory 258) executable by at least one of the one or more processors 256 to instruct the system 250 to perform various actions. As an example, the system 250 may be configured such that the instructions 270 provide for establishing a framework, for example, that can perform network modeling (see, e.g., the PIPESIM framework of the example of FIG. 1, etc.) and/or other modeling. As an example, one or more methods, techniques, etc. may be performed using one or more sets of instructions, which may be, for example, the instructions 270 of FIG. 2. As an example, the instructions 270 may include instructions for one or more of monitoring one or more portions of the network of equipment 230, controlling one or more portions of the network of equipment 230, receiving data from one or more portions of the network of equipment 230, etc.

As an example, various graphics in FIG. 2 may be part of a graphical user interface (GUI) that can be generated using executable instructions that may be executable locally and/or remotely using local and/or remote display devices (e.g., a mobile device, a workstation, etc.).

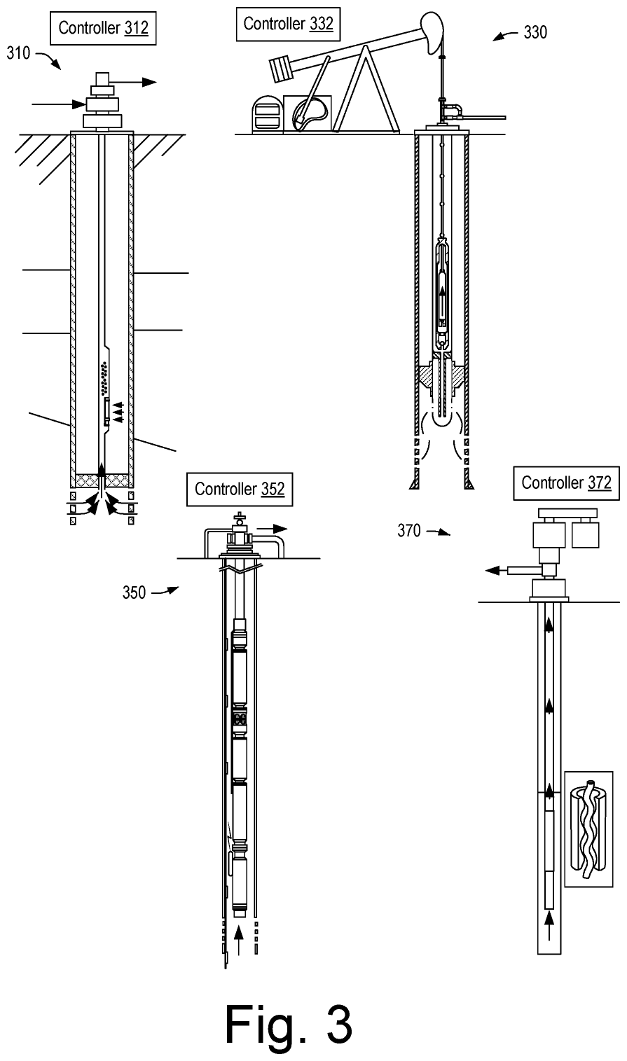

FIG. 3 shows examples of equipment 310, 330, 350 and 370 that can be utilized in the field to move fluid. As an example, the geologic environment 150 of FIG. 1 and/or the geologic environment 210 of FIG. 2 can include one or more instances of the examples of equipment 310, 330, 350 and 370. As shown, the equipment 310 can include gas-lift equipment, the equipment 330 can include sucker rod pump equipment, the equipment 350 can include electric submersible pump (ESP) equipment, and the equipment 370 can include progressive cavity pump (PCP) equipment.

In FIG. 3, the equipment 310, 330, 350 and 370 can be artificial lift equipment, where one or more controllers 312, 332, 352 and 372 can be included with the equipment 310, 330, 350 and 370 and/or operatively coupled to the equipment 310, 330, 350 and 370. In such an example, one or more features of the system 250 may be included in the one or more controllers 312, 332, 352 and 372 and/or operatively coupled to the one or more controllers 312, 332, 352 and 372.

Artificial lift equipment can add energy to a fluid column in a wellbore with the objective of initiating and/or improving production from a well. Artificial lift systems can utilize a range of operating principles (e.g., rod pumping, gas lift, electric submersible pumps, etc.). As such, artificial lift equipment can operate through utilization of one or more resources (e.g., fuel, electricity, gas, etc.).

Gas lift is an artificial-lift method in which gas is injected into production tubing to reduce hydrostatic pressure of a fluid column. The resulting reduction in bottomhole pressure allows reservoir liquids to enter a wellbore at a higher flow rate. In gas lift, injection gas can be conveyed down a tubing-casing annulus and enter a production train through a series of gas-lift valves. In such an approach, a gas-lift valve position, operating pressure and gas injection rate may be operational parameters (e.g., determined by specific well conditions, etc.).

A sucker rod pump is an artificial-lift pumping system that uses a surface power source to drive a downhole pump assembly. For example, a beam and crank assembly can create reciprocating motion in a sucker rod string that connects to a downhole pump assembly. In such an example, the pump can include a plunger and valve assembly to convert the reciprocating motion to vertical fluid movement. As an example, a sucker rod pump may be driven using electricity and/or fuel. For example, a prime mover of a sucker rod pump can be an electric motor or an internal combustion engine.

An ESP is an artificial-lift system that utilizes a downhole pumping system that is electrically driven. In such an example, the pump can include staged centrifugal pump sections that can be specifically configured to suit production and wellbore characteristics of a given application. ESP systems may provide flexibility over a range of sizes and output flow capacities.

A PCP is a type of a sucker rod-pumping unit that uses a rotor and a stator. In such an approach, rotation of a rod by means of an electric motor at surface causes fluid contained in a cavity to flow upward. A PCP may be referred to as a rotary positive-displacement unit.

In the examples of FIG. 3, one or more sensors may be included. For example, consider a gauge coupled to a downhole end of an ESP where signals from sensors of the gauge can be transmitted to surface equipment using a power cable and/or a dedicated gauge cable. For example, consider the PHOENIX gauge (SLB, Houston, Texas), which include sensors that can measure intake pressure, temperature, motor oil temperature, winding temperature, vibration, current leakage and/or pump discharge pressure. A gauge may be operatively coupled to a controller, which may, for example, provide controls for backspin of an ESP, sanding of an ESP, flux of an ESP and gas related issues of an ESP. For example, during operation where sand is present (e.g., suspended solid matter, etc.), sand may accumulate in one or more stages of an ESP where a control scheme may act to rid the ESP of at least a portion of the sand.

As an example, a PCP may be suitable for use in production for wells characterized by highly viscous fluid and high sand cut where the PCP has some sand-lifting capability. However, sand may accumulate where a control scheme may be utilized to rid the PCP of at least a portion of the sand.

As an example, a sucker rod pump may be operable via as a stroke-through pump to release sand and other material. In such an example, to minimize damage to a plunger and barrel, a grooved-body plunger may be used to catch and carry the sand away from those components.

As an example, gas lift equipment may be utilized in applications where abrasive materials, such as sand, may be present and can be used in low-productivity, high-gas/oil ratio-wells or deviated wellbores. As an example, gas lift equipment such as pocketed mandrels can utilize slickline-retrievable gas lift valves, which may be pulled and replaced without disturbing tubing.

As an example, equipment may include water flooding equipment. For example, consider an enhanced oil recovery (EOR) process in which a small amount of surfactant is added via appropriate equipment to an aqueous fluid injected to sweep a reservoir. In such an example, presence of surfactant reduces the interfacial tension between oil and water phases and may also alter wettability of reservoir rock (e.g., to improve oil recovery). In such an example, movement of fluid (e.g., oil and/or water) and/or presence of surfactant may carry particles of the reservoir rock to a production well or production wells where such particles (e.g., sand) can result in a sand event, whether one or more of the production well or wells include artificial lift equipment or not. As water flooding becomes more prevalent globally, an increase in sand related issues may be expected (e.g., sand influx into production wells).

As an example, equipment can include a choke or chokes, which can include a surface choke and/or a downhole choke. A choke is a device that includes an orifice that can be used to control flow of fluid through the orifice, for example, to control fluid flow rate, downstream system pressure, etc. Chokes are available in various configurations, which include fixed and adjustable chokes. An adjustable choke enables fluid flow and pressure parameters to be changed as desired (e.g., for process, production, etc.).

An adjustable choke includes a valve that can be adjusted to control well operations, for example, to reduce pressure of a fluid from high pressure in a closed wellbore to atmospheric pressure. An adjustable choke valve may be adjusted (e.g., fully opened, partially opened or closed) to control pressure drop. As an example, an adjustable choke may be manually adjustable or adjustable via a controller that may be integral to or operatively coupled to the adjustable choke. A controller for an adjustable choke may respond to locally generated and/or remotely generated signals.

A downhole choke or bottom hole choke can be a downhole device used to control fluid flow under downhole conditions. As an example, a downhole choke may be removable via slickline intervention where the downhole choke may be located in a landing nipple in a tubing string. In some scenarios, a downhole chock may be used as a flow regulator and to take part of the pressure drop downhole, which may help to reduce potential of hydrate issues.

As an example, a system may be a pump system that includes one or more mechanisms to reciprocate a rod string where the rod string can include rods that are joined via couplings. For example, a rod can include opposing threaded ends, which may be referred to as pins, where each of the ends can be threaded into mating threads of a coupling. In such an example, a long rod string can be assembled that is made up of a series of rods where the rods are joined by couplings. Such a rod string may be meters in length.

As an example, a rod may be a sucker rod. A sucker rod can be a steel rod that is used to make up a mechanical assembly between the surface and downhole components of a rod pumping system. As an example, a sucker rod may be a non-standardized length or a standardized length. As an example, a standardized length of a sucker rod may be in a range from about 25 ft to about 30 ft (e.g., about 7 m to about 9 m).

As an example, a pumping system can be an artificial-lift pumping system that can be powered using a surface power source to drive a downhole pump assembly. As an example, a pumping system can include a beam and crank assembly that creates reciprocating motion in a rod string that connects to the downhole pump assembly. In such an example, the downhole pump assembly can include a plunger and valve sub-assembly that can convert reciprocating motion to vertical fluid movement.

As an example, an electric motor may be utilized to reciprocate a rod string, optionally via one or more belt or chain drives. For example, a belt driven pumping unit can include a belt that is coupled to a rod string for reciprocating the rod string vertically within a well as the belt is driven by an electric motor. As an example, a pump may be a sucker rod pump that includes a sucker rod string.

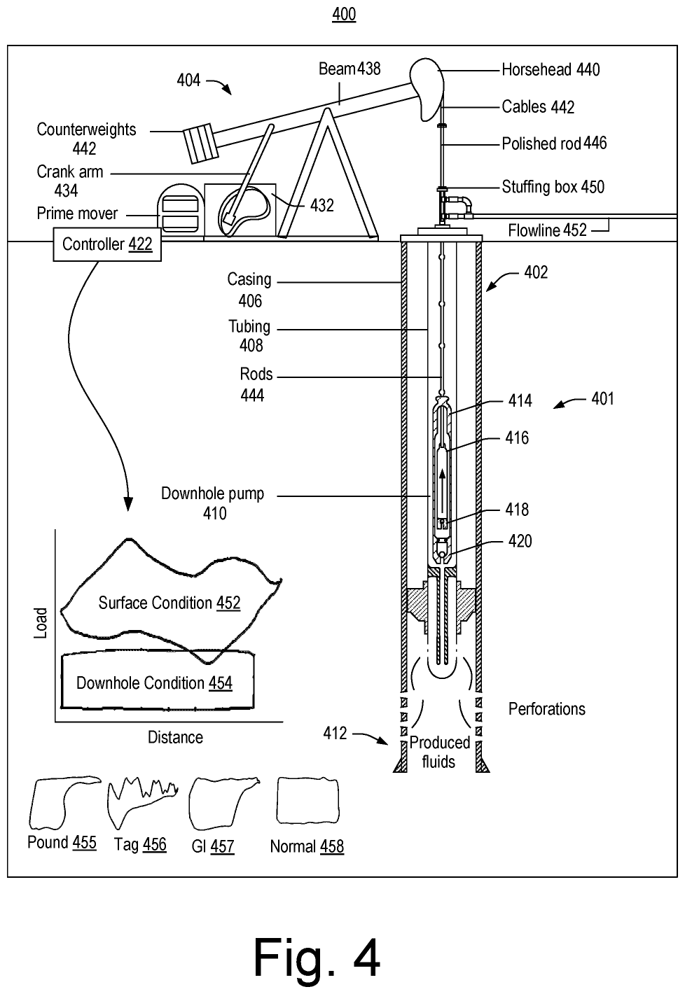

FIG. 4 shows an example of a system 400 that includes a pump assembly 401 as driven by a pump drive system 404 that is operatively coupled to a controller 422. In the example of FIG. 4, the pump assembly 401 and drive system 404 are arranged as a beam pump. As shown in FIG. 4, a walking beam 438 reciprocates a rod string 444 that includes a polished rod portion 446 that can move in a bore of a stuffing box 450 of a well head assembly that includes a discharge port in fluid communication with a flowline 452. The rod string 444 can be suspended from the walking beam 438 via one or more cables 442 hung from a horse head 440 for actuating a downhole pump 410 of the pump assembly 401 where the downhole pump 410 is positioned in a well 402, for example, near a bottom 412 of the well 402.

A well in a subterranean environment may be a cased well or an open well or, for example, a partially cased well that can include an open well portion or portions. In the example of FIG. 4, the well 402 includes casing 406 that defines a cased bore where tubing 408 is disposed in the cased bore. As shown, an annular space can exist between an outer surface of the tubing 408 and an inner surface of the casing 406.

In the example of FIG. 4, the walking beam 438 is actuated by a pitman arm (or pitman arms), which is reciprocated by a crank arm (or crank arms) 434 driven by a prime mover 430 (e.g., electric motor, etc.). As shown, the prime mover 430 can be coupled to the crank arm 434 through a gear reduction mechanism, such as gears of a gearbox 432. As an example, the prime mover 430 can be a three-phase AC induction motor that can be controlled via circuitry of the controller 422, which may be connected to a power supply. The gearbox 432 of the pump drive system 404 can convert electric motor torque to a low speed, high torque output for driving the crank arm 434. The crank arm 434 can be operatively coupled to one or more counterweights 442 that serve to balance the rod string 444 and other equipment as suspended from the horse head 440 of the walking beam 438. A counterbalance may be provided by an air cylinder such as those found on air-balanced units.

The downhole pump 410 can be a reciprocating type pump that includes a plunger 416 attached to an end of the rod string 444 and a pump barrel 414, which may be attached to an end of the tubing 408 in the well 402. The plunger 416 can include a traveling valve 418 and a standing valve 420 positioned at or near a bottom of the pump barrel 414. During operation, for an up stroke where the rod string 444 translates upwardly, the traveling valve 418 can close and lift fluid (e.g., oil, water, etc.) above the plunger 416 to a top of the well 402 and the standing valve 420 can open to allow additional fluid from a reservoir to flow into the pump barrel 414. As to a down stroke where the rod string 444 translates downwardly, the traveling valve 418 can open and the standing valve 420 can close to prepare for a subsequent cycle. Operation of the downhole pump 410 may be controlled such that a fluid level is maintained in the pump barrel 414 where the fluid level can be sufficient to maintain the lower end of the rod string 444 in the fluid over its entire stroke.

As an example, the system 400 can include a beam pump system. As explained, a prime mover can rotate a crank arm, whose movement is converted to reciprocal movement through a beam. The beam can include counterweights or a compressed air cylinder to help reduce load on the beam pump system during the upstroke. The beam can be attached to a polished rod by cables hung from a horsehead at the end of the beam. The polished rod can pass through a stuffing box and be operatively coupled to the rod string. As explained, the rod string can be lifted and lowered within the production tubing of a cased well by the reciprocal movement of the beam, enabling the downhole pump to capture and lift formation fluid(s) in a direction toward surface (e.g., with a flow vector component against gravity) in the tubing and through a pumping tee that directs the fluid into a flowline.

As an example, the prime mover may be an internal combustion engine or an electric motor that provides power to the pumping unit. As an example, a prime mover can deliver high-speed, low-torque power to a gear reducer, which converts that energy into the low-speed, high-torque energy utilized by the surface pump. As shown in FIG. 4, a beam pumping unit, beam pump system or merely beam pump, converts the rotational motion of the prime mover into a reciprocating vertical motion that lifts and lowers a rod string connected to a subsurface pump.

Some aspects of a system can include prime mover type; pumping unit size, stroke length and speed setting; rod and tubing diameter; and downhole pump diameter, for example, based at least in part on reservoir fluid composition, wellbore fluid depth and reservoir productivity.

As an example, a design framework may facilitate some decisions as to design, for example, to arrive at a desired pump speed to attain production targets without overloading the system or overwhelming the formation's ability to deliver fluids to a wellbore.

Beam pumps may be constructed in a variety of sizes and configurations. Some systems include design aspects that can aim to better manage torque, rod wear and/or footprint. For example, as to some design aspects, consider locating counterweights on the crank arm or on the beam and use of compressed air rather than weight to assist in load balancing. Further examples can involve changes to crank, gear reducer and motor position relative to the beam, as well as alternative beam designs, where such factors may change system loading.

As an example, a system may place heavier rods, or sinker bars, in the lower section of the rod string to keep the rod string in tension, which reduces buckling and may help prevent contact with the tubing wall. Rod strings may also include stabilizer bars between sinker bars to centralize the rods, further reducing tubing wear.

Rod guides, which may be made of reinforced plastics, may be molded onto steel rods at depths where engineers may predict the rods will experience side loading due to a deviated wellbore path. The guides can act like bearings between the tubing wall and the rod to prevent rod and tubing wear. Sliding guides may be able to move between molded guides during the pump cycle, aiding production by scraping paraffin from the tubing wall, which helps prevent well plugging. A rod rotator or tubing rotator may be used to rotate the rod a small fraction of a revolution on each stroke of the pumping unit to further extend rod string life. As an example, slow rotation of rod guides may help scrape paraffin from the tubing wall.

Sucker rods may be connected to the surface pumping unit by a polished rod. A polished rod, for example, made of standard alloy steel and hard-surface spray metal coating, can support loads created during a pump cycle and help to ensure a seal through a stuffing box at a top of a well. The stuffing box can be attached to a wellhead or pumping tee and can form a low-pressure tight seal against a polished rod. The seal can form a barrier between a well and atmosphere and may allow flow to be diverted into a flowline, for example, via a pumping tee.

A dynamometer is an instrument used in sucker-rod pumping to record the variation between the polished rod load and the polished rod displacement. A dynamometer card (e.g., dynacard) is a record made by a dynamometer. An analysis of dynamometer measurements may reveal a defective pump, leaky tubing, inadequate balance of the pumping unit, a partially plugged mud anchor, gas locking of the pump or an undersized pumping unit. A dynamometer card may be in the form of a graph, such as a dynagraph (e.g., a dynacard graph). As an example, a dynacard or dynagraph may be generated in digital form, for example, as a digital image.

FIG. 4 also shows a surface condition plot 452 and a downhole condition plot 454, which are plots of load versus distance with respect to time, for example, with respect to one or more cycles of a pump such as a sucker-rod pump.

As to the downhole condition plot 454, as mentioned, it can be based on a model. Such a model may include various types of factors such as, for example, velocity of sound in a rod, modulus of elasticity of the material of rods, length of a rod string, number of increments in position, number of discretization in time, pump velocity (e.g., cycles per minute, stroke per minute, etc.), rod stroke length, rod diameter, specific weight of rod material, a factor of dimensionless damping, specific gravity of fluid, diameter of tubing, etc.

As an example, a dynamometer card can exhibit shape variations, which may facilitate behavior and/or condition identification and/or control. For example, shapes can correspond to dynamic issues such as a perfect trace, rod stretch, partial pump fill, acceleration and harmonics, low filage, tapping down, tapping up, worn barrel, delayed traveling valve (tv) sensing, bad tv, bad standing valve (sv), pounding hard, gas lock or bad sv, deep rod part, excessive harmonics, high fluid level, excessive friction, excessive rod stretch, stuck pump, bad position signal, bad load signal or galded pump, etc. The foregoing types of issues can depend on equipment specifics, site specifics, etc., noting that one or more other types of issues may be identified using pump equipment data.

In the example of FIG. 4, some examples of data and associated behaviors are shown, which include data indicative of pound behavior 455, data indicative of tag behavior 456, data indicative of gas interference (GI) behavior 457 and data indicative of normal behavior 458.

As an example, a sucker rod pump may exhibit behavior such as fluid pound. In fluid pound, each impact load imparted to the pump's plunger causes the rods to buckle and hit the tubing where high load impacts, which beat out the traveling valve (tv) ball and seat, can causes the pump's valve rod to buckle creating side-loading of the plunger onto the barrel where stresses imparted in the rod can drastically increase rod loading and reduce the rod life. Further, impact load can eventually transmit up the rod-string and damage tightly inter-locking teeth in a gearbox.

As an example, a sucker rod pump may exhibit behavior such as gas interference. While gas interference (or gas pound) is in many regards similar to fluid pound, it does not create nearly the same type of impact load; however, volumetrically it can be just as inefficient. And, due to the inefficiency, in the presence of gas interference, additional strokes can be required that can be quite damaging to the equipment. Also, gas that enters a pump eventually makes its way up the tubing string, which can be a cause of stuffing box leaks. Gas interference can make pump performance erratic.

As an example, a suck rod pump may exhibit behavior such as pump tagging, which may be referred to simply as tagging. Tagging can occur deliberately, for example, where a pump is spaced such that at the bottom of the stroke, actual contact, that tends to be light, is made between the plunger and the bottom of the pump. While some light pump tagging may have a place in the oilfield, tagging can be a behavioral issue, particularly where tagging is beyond “light”. As to what is a “light” tag, that can be subjective when handled by a human, particularly a human that may not have the level of knowledge of a subject matter expert (SME), which may be a domain expert. For example, a human may report that a well has a “light” tag where it might feel “light” at surface, but it is not known how “light” the tag actually is downhole, which may be a considerable distance downhole (e.g., hundreds of meters or more). And when not periodically monitored, a “light” tag may become a little heavier a couple weeks later. As fiberglass rod strings absorb much of the tag and do not transmit the shock wave vertically as effectively as steel does, a “light” tag on a fiberglass rod well might be twice as hard as “light” tag on a steel rod string. Tagging can be destructive to a pump, rods and tubing, along with reducing downhole plunger travel. Tagging behavior may be associated with inefficiency, for example, where a pump can lose a certain percentage of its total downhole stroke-length as a result of the tag. Also, pump tagging tends to hammer the pump into the seating nipple (e.g., making it more difficult to unseat next pull).

While details of a particular type of equipment are shown in FIG. 4, other types of equipment can have their own associated details, which can include features that may be alternative to, additional to, different than, etc., the features of the system 400 of FIG. 4. And, while pumps are mentioned, as explained, field equipment can include equipment other than pumps or additional to one or more pumps.

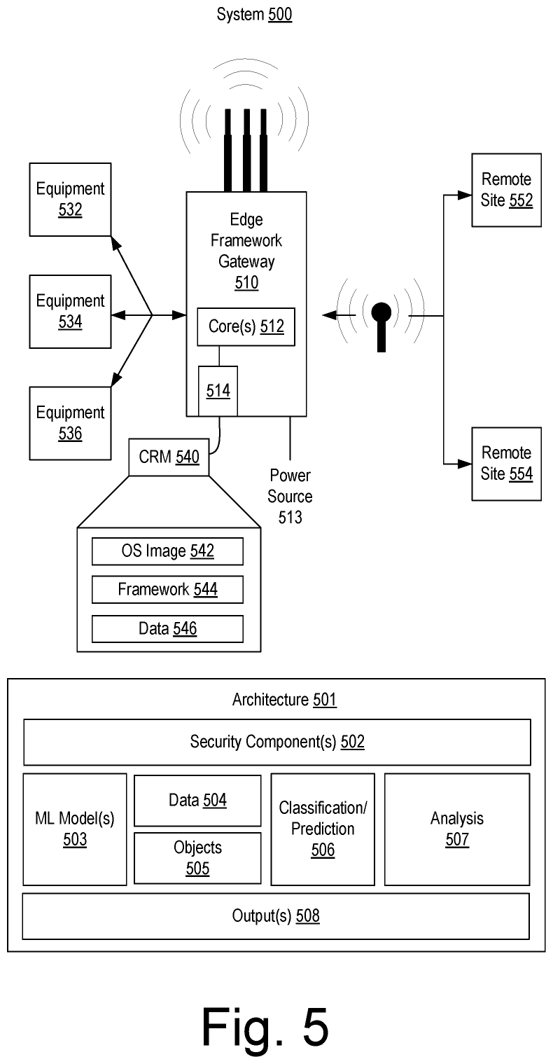

FIG. 5 shows an example of a system 500 and an example of an architecture 501 where the system 500 can include various local components that can be in communication with one or more remote components. As shown in the example of FIG. 5, the architecture 501 can provide for one or more security components 502, one or more machine learning models 503, data 504, objects 505, classification and/or prediction techniques 506 (e.g., recognition, detection, classification, prediction, etc.), analysis techniques 507 and output(s) 508. As an example, the system 500 may be operatively coupled to one or more types of equipment, which may include one or more pumps and/or one or more non-pump equipment. As an example, the system 500 may operate as a controller, a motor controller, etc., and/or provide information to a controller, a motor controller, etc.

As shown, the system 500 can include a power source 513 (e.g., solar, generator, batter, grid, etc.) that can provide power to an edge framework gateway 510 that can include one or more computing cores 512 and one or more media interfaces 514 that can, for example, receive a computer-readable medium 540 that may include one or more data structures such as an operating system (OS) image 542, a framework 544 and data 546. In such an example, the OS image 542 may cause one or more of the one or more cores 512 to establish an operating system environment that is suitable for execution of one or more applications. For example, the framework 544 may be an application suitable for execution in an established operating system in the edge framework gateway 510.

In the example of FIG. 5, the edge framework gateway 510 (“EF”) can include one or more types of interfaces suitable for receipt and/or transmission of information. For example, consider one or more wireless interfaces that may provide for local communications at a site such as to one or more pieces of local equipment, which can include equipment 532, equipment 534 and equipment 536 and/or remote communications to one or more remote sites 552 and 554. In such an example, lesser or more equipment may be included.

As an example, the equipment 532, 534 and 536 may include one or more types of equipment such as, for example, one or more instances of the equipment 310, the equipment 330, the equipment 350 and the equipment 370 of FIG. 3. As an example, equipment may include non-artificial lift equipment and/or artificial lift equipment.

As an example, the EF 510 may be installed at a site where the site is some distance from a city, a town, etc. In such an example, the EF 510 may be accessible via a satellite communication network and/or one or more other networks where data, control instructions, etc., may be transmitted, received, etc.

As an example, one or more pieces of equipment at a site may be controllable locally and/or remotely. For example, a local controller may be an edge framework-based controller that can issue control instructions to local equipment via a local network and a remote controller may be a cloud-based controller or other type of remote controller that can issue control instructions to local equipment via one or more networks that reach beyond the site. As an example, a site may include features for implementation of local and/or remote control. As an example, a controller may include an architecture such as a supervisory control and data acquisition (SCADA) architecture.

Satellite communication tends to be slower and more costly than other types of electronic communication due to factors such as distance, equipment, deployment and maintenance. For wellsites that do not have other forms of communication, satellite communication can be limiting in one or more aspects. For example, where a controller is to operate in real-time or near real-time, a cloud-based approach to control may introduce too much latency.

As shown in the example of FIG. 5, the EF 510 may be deployed where it can operate locally with the one or more pieces of equipment 532, 534 and 536, etc. As an example, the EF 510 may include switching and/or communication capabilities, for example, for information transmission between equipment, etc.

As desired, from time to time, communication may occur between the EF 510 and one or more remote sites 552, 554, etc., which may be via satellite communication where latency and costs are tolerable. As an example, the CRM 540 may be a removable drive that can be brought to a site via one or more modes of transport. For example, consider an air drop, a human via helicopter, plane, boat, etc.

As explained with respect to FIG. 5, an EF may execute within a gateway such as, for example, an AGORA gateway (SLB, Houston, Texas), which can include one or more processors, memory, etc., which may be deployed as a “box” that can be locally powered and that can communicate locally with other equipment via one or more interfaces. As an example, one or more pieces of equipment may include computational resources that can be akin to those of an AGORA gateway or more or less than those of an AGORA gateway. As an example, an AGORA gateway may be a network device with various networking capabilities.

As an example, a gateway can include one or more features of an AGORA gateway (e.g., v.202, v.402, etc.) and/or another gateway. For example, consider features such as an INTEL ATOM E3930 or E3950 dual core with DRAM and an eMMC and/or SSD. Such a gateway may include a trusted platform module (TPM), which can provide for secure and measured boot support (e.g., via hashes, etc.). A gateway may include one or more interfaces (e.g., Ethernet, RS485/422, RS232, etc.). As to power, a gateway may consume less than about 100 W (e.g., consider less than 10 W or less than 20 W). As an example, a gateway may include an operating system (e.g., consider LINUX DEBIAN LTS or another operating system). As an example, a gateway may include a cellular interface (e.g., 4G LTE with global modem/GPS, 5G, etc.). As an example, a gateway may include a WIFI interface (e.g., 802.11 a/b/g/n). As an example, a gateway may be operable using AC 100-240 V, 50/60 Hz or 24 VDC. As to dimensions, consider a gateway that has a protective box with dimensions of approximately 10 in ×8 in ×4 in (e.g., 25 cm×20.3 cm×10.1 cm).

As an example, a gateway may be part of a drone. For example, consider a mobile gateway that can take off and land where it may land to operatively couple with equipment to thereby provide for control of such equipment. In such an example, the equipment may include a landing pad. For example, a drone may be directed to a landing pad where it can interact with equipment to control the equipment. As an example, a wellhead can include a landing pad where the wellhead can include one or more sensors (e.g., temperature and pressure) and where a mobile gateway can include features for generating fluid flow values using information from the one or more sensors. In such an example, the mobile gateway may issue one or more control instructions (e.g., to a choke, a pump, etc.).

As an example, a gateway itself may include one or more cameras such that the gateway can record conditions. For example, consider a motion detection camera that can detect the presence of an object. In such an example, an image of the object and/or an analysis (e.g., image recognition) signal thereof may be transmitted (e.g., via a satellite communication link) such that a risk may be assessed at a site that is distant from the gateway.

As an example, a gateway may include one or more accelerometers, gyroscopes, etc. As an example, a gateway may include circuitry that can perform seismic sensing that indicates ground movements. Such circuitry may be suitable for detecting and recording equipment movements and/or movement of the gateway itself. As an example, a gateway can include one or more sensors that can detect local shock and/or vibration, which may be associated with equipment operation, movement of fluid, etc.

As explained, a gateway can include features that enhance its operation at a remote site that may be distant from a city, a town, etc., such that travel to the site and/or communication with equipment at the site is problematic and/or costly. As explained, a gateway can include an operating system and memory that can store one or more types of applications that may be executable in an operating system environment. Such applications can include one or more security applications, one or more control applications, one or more simulation applications, etc.

As an example, various types of data may be available, for example, consider real-time data from equipment and ad hoc data. In various examples, data from sources connected to a gateway may be real-time, ad hoc data, sporadic data, etc. As an example, lab test data may be available that can be used to fine tune one or more models (e.g., locally, etc.). As an example, data from a framework such as the AVOCET framework may be utilized where results and/or data thereof can be sent to the edge. As an example, one or more types of ad hoc data may be stored in a database and sent to the edge.

As to real-time data, it can include data that are acquired via one or more sensors at a site and then transmitted after acquisition, for example, to a framework, which may be local, remote or part local and part remote. Such transmissions may be as streams (e.g., streaming data) and/or as batches. As to batches, a buffer may be utilized where an amount of data may be stored and then transmitted as a batch. In various instances, real-time data may be characterized using a sampling rate or sampling frequency. For example, consider 1 Hz as a sampling frequency that is adequate to track various types of physical phenomena that can occur during well operations. As an example, data may be acquired according to a cyclical frequency of field equipment. For example, consider a cycle of a rod pump such as in the example of FIG. 4. As an example, a sensor and/or a framework may provide for adjustment of sampling (e.g., at the sensor and/or at the framework). In various instances, data from multiple sensors may be at the same sampling rate or at one or more sampling rates.

As explained, various systems may operate in a local manner, optionally without access to a network such as the Internet. For example, a site may be relatively remote where satellite communication exists as a main mode of communication, which may be costly and/or low bandwidth. In such scenarios, security may resort to local features rather than a remote feature such as a remote authentication server.

An authentication server can provide a network service that applications use to authenticate credentials, which may be or include account names and passwords of users (e.g., human and/or machine). When a client submits a valid credential or credentials to an authentication server, the authentication server can generate a cryptographic ticket that the client can subsequently use to access one or more services.

In the example of FIG. 5, the edge framework 544 can be an edge-enabled data processing framework. As an example, such a framework can include features to perform one or more of the followings tasks: real-time data cleansing to synchronize information from existing well metrology (e.g., wellhead, tubing, flow, pump, etc.); executing one or more machine learning (ML) (e.g., including self-learning) models in real-time (e.g., one or more ML models that can identify one or more issues, etc.); and conveying a control set point to a controller (e.g., an actuatable valve, etc.) and/or one or more other pieces of equipment. As mentioned, an edge framework may be deployable using downhole circuitry, which may be downhole circuitry operatively coupled to surface circuitry, etc.

The system 500 can be part of an infrastructure that serves as a secure gateway to transmit surveillance into an operator's surveillance station and/or its own surveillance platform. The presence of such a gateway can also support an operator for introduction of one or more additional IIOT (industrial internet of things) implementations.

As an example, one or more of the controllers of FIG. 3 and FIG. 4 may include or provide access to one or more frameworks, applications, etc. As an example, one or more of the controllers of FIG. 3 and FIG. 4 can include one or more features of the system 500 of FIG. 5. As an example, the system 250 of FIG. 2 may include one or more instances of the system 500 of FIG. 5.

As an example, a system can provide for automated monitoring of artificial intelligence (AI) model performance on a number of field devices. Such a system can, for example, identify model drift due to differences in data, which can include training and inference data, etc. In response, the system can automatically trigger model retraining with new available data, while tracking model versions and artifacts and automatically building, testing and deploying new retrained models to the field devices, which may be edge devices.

A system can include a feedback loop that can provide a portal such as a web portal for assessments. For example, consider one or more subject matter experts (SMEs) that can access features of the system in a manner that allows for validation of results from an AI model running on an edge device. Such a system can be facilitated by utilization of automation features for monitoring and identifying model drift, which may be characterized according to degradation of a model's prediction power due to changes in the environment, etc. A system can provide for retraining and/or rebuilding one or more models, for example, with newly available data, which, for supervised learning, may include labeled data (e.g., machine labeled, human labeled, etc.). A system can include a validator that can execute a validation process for quality control on a new model where a deployer can push a validated new model to one or more edge devices.

As an example, a method can be organized as a workflow, which can be or include an AI workflow that classifies equipment behavior based at least in part on field data. As an example, consider data such as surface cards and/or downhole cards of rod lift pumps using machine learning to trigger mitigation and optimization processes (e.g., on the edge). For example, consider the load versus distance plot of FIG. 4 that shows the surface condition plot 452 and the downhole condition plot 454, which may be handled together and/or separately, optionally as images, by one or more ML models that can classify such plots with respect to behaviors and/or conditions. While a classification approach is mentioned, one or more of classification and prediction may be utilized.

As an example, multiple models may be utilized, which may form an ensemble. For example, consider an ensemble of one or more types of models such as binary classification models, deep learning models, etc. An ensemble approach may provide for selection of an appropriate model or models, which may aim to perform on a time frame that matches data availability and/or equipment behavior characteristics of field equipment. For example, where data are available at a high frequency and where behavior may change relatively rapidly, a model that can execute relatively rapidly may be selected over a model with a longer execution time; noting that where behaviors of equipment have different time frames, one or more models may be selected that can adequately handle such different time frames.

As explained, where a trained, deployed model, itself, can monitored for performance issues such as model drift and/or other types of degradation. For example, if a trained, deployed model exhibits degradation in its ability to classify and/or predict behaviors and/or conditions, a signal can be generated to notify a machine and/or a human as to the model's performance issue such that retraining (or rebuilding) can occur. As explained, a human-in-the-loop (HITL) approach may be implemented where the human is an expert that can readily assess model performance and data and, where appropriate, can select particular data for use in retraining and/or label particular data as being associated with a behavior and/or a condition for use in retraining. In such a manner, a number of pieces of field equipment can be appropriately monitored and/or controlled through use of machine learning models that are themselves subject to scrutiny and retraining and/or rebuilding. As explained, automation can be utilized to identify one or more models that are exhibiting issues, which may conserve and focus resources for particular model-related tasks.

As explained, an automated system can monitor and identify degradation of model performance. Such a system can provide for retraining of a model with new data when required along with validation and deployment of a retrained model to one or more edge devices. In a particular installation, a retraining cycle can be completed within several hours, which can help to assure proper equipment operation and control. Where such equipment is for pumping hydrocarbons from a well in fluid communication with a reservoir, targets may be met more readily, for example, when compared to a non-automated approach that demands periodic model-by-model inspection and assessment. As explained, an approach that can automatically identify model issues and streamline handling of such issues can help in meeting planned targets with respect to equipment performance, fluid production, resource utilization, etc. An automated approach may even allow for reassessment of targets as less downtime (e.g., non-productive time) may be expected. For example, a manual approach may have a cycle time of several weeks where the manual approach is an iterative and repetitive process for numerous field sites, which involves data scientists and SMEs to perform manual model updates and deployment. As explained, an automated system that expedites issue identification, expert assessment, model retraining, validation and deployment can have a cycle time of several hours, rather than several weeks (e.g., 3 hours compared to over 400 hours).

As an example, a system can provide for scaling and deployment of machine learning workflows in operations that may demand incremental updates to account for model drift, addition of new wells, improvement of performance indicators (PIs) and enhancement of solution robustness. In a manual approach, such operations tend to be iterative and involve additional repetitive efforts from data scientists. In contrast, automation can make use of data scientists and/or subject matter experts more efficient for management of AI-enabled solutions on edge devices (e.g., IIOT devices) where efficiency gains are at least in part from minimizing manual intervention, for example, as achieved by machine automation.

As an example, consider pump equipment deployed in a field, which may include tens of pumps, hundreds of pumps or thousands of pumps. Such pump equipment can generate a considerable amount of data such as, for example, card data (e.g., dynacards, etc.). Real time pump data such as load and position (e.g., distance) can be acquired by an edge device at, for example, a one-minute frequency (e.g., a stroke cycle of one minute). As explained, a trained ML model deployed on an edge device can process such data (e.g., as time series data, image data, etc.) to make classifications and/or predictions as to behaviors and/or conditions. Such results can be automatically pushed to a cloud-based application where a HITL (e.g., an expert) can see the results from the ML model, validate them and make adjustments as appropriate. A machine learning operationalization (MLOps) pipeline can automatically monitor data channels from edge devices and notify a HITL for purposes of identifying particular data and/or labeling particular data as may be helpful to address identified ML model drift. In such an approach, the MLOps pipeline can automatically update a training dataset with the latest available data and can trigger model retraining, for example, if model drift surpasses a pre-configured threshold, which may be adjustable, optionally on an issue-by-issue basis. For example, if model drift is tolerable for some types of behaviors and/or conditions, a threshold may be more relaxed compared to a threshold for other types of behaviors and/or conditions that may have a substantial impact on one or more targets.

As mentioned, for dynacards, shapes can correspond to one or more dynamic issues such as a perfect trace, rod stretch, partial pump fill, acceleration and harmonics, low filage, tapping down, tapping up, worn barrel, delayed tv sensing, bad tv, bad sv, pounding hard, gas lock or bad sv, deep rod part, excessive harmonics, high fluid level, excessive friction, excessive rod stretch, stuck pump, bad position signal, bad load signal or galded pump, etc. As explained, a trained ML model may be utilized to process pump equipment data to classify and/or predict one or more issues (e.g., as behaviors, conditions, etc.). As an example, local controller may provide for control using output from a trained ML model. For example, where gas lock is detected via a trained ML model by classification and/or prediction using pump equipment data, a controller may control the pump equipment according to a specialized process that aims to alleviate gas lock such that normal pump operation can be achieved. As to a condition such as excessive rod stretch, a controller may issue a repair instruction and/or an adjustment instruction such that forces are reduced in an effort to minimize further stretch.

As an example, a system can, once a ML model is retrained, capture the artifacts such as confusion matrixes, accuracy scores and F1 scores. Such information (e.g., issue metadata, etc.) can be utilized for one or more purposes (e.g., QA, rebuilding, etc.). Once a new model is available, such a system can then package the new model into a container, deploy it on a container instance, and run pre-configured integration tests to ensure the new model is working as expected. As an example, results of a validation process can be automatically transmitted to notify a machine and/or a human. Where a HITL approach is taken, an acceptance signal from a human may be an indication that the new model can be brought online at a field site or field sites (e.g., as implemented at an edge device). In various instances, one or more instances of a model at one or more sites may result in a trigger where instances of a new model are deployed to more than one site or, for example, deployed to a site or a limited number of sites as part of a phase-in approach, which can include monitoring followed by roll-out to additional sites in a subsequent phase.

As an example, a system can be a computational framework that is flexible, repeatable, and generalized for adoption in or conversion of manual end-to-end machine learning applications specific to IIOT devices.

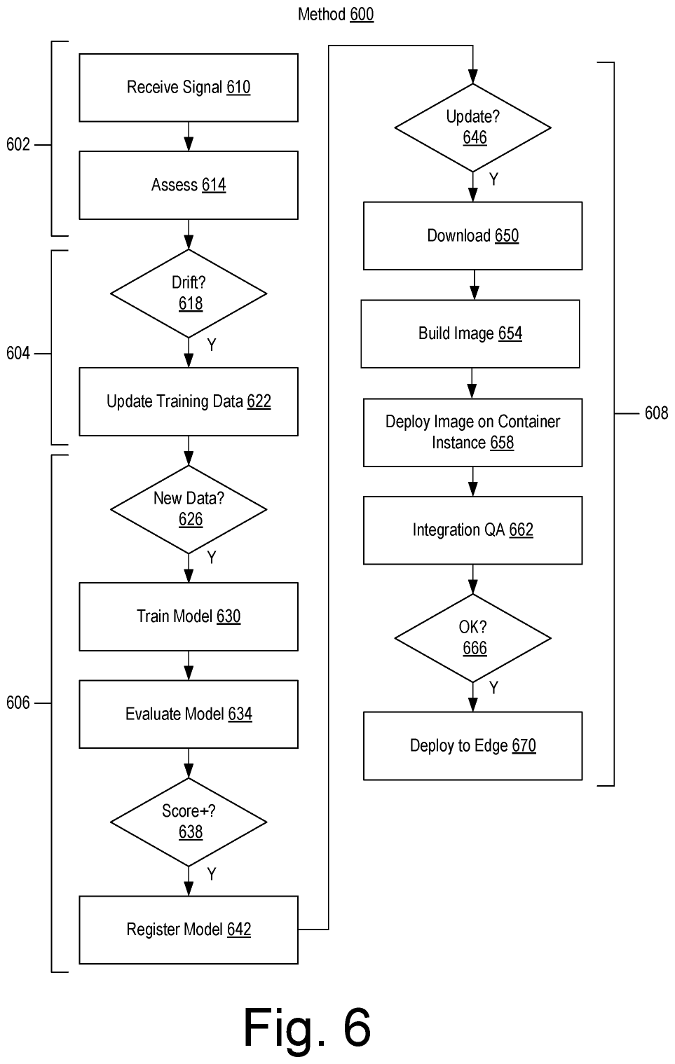

FIG. 6 shows an example of a method 600 that includes various processes 602, 604, 606 and 608 where the process 602 can be an expert review process, the process 604 can be a model issue detection process, the process 606 can be a model training/retraining process and the process 608 can be a model deployment process.

As shown, the method 600 can include a reception block 610 for reception of a signal indicative of model drift or other model issue(s), an assessment block 614 for assessing a model, a decision block 618 for deciding whether, based on an assessment, model drift and/or another model issue exists, an update block 622 for updating training data, a decision block 626 for deciding whether new data are available (e.g., data for training with and/or without labels, which may be from the assessment block 614, etc.), a train block 630 for performing training and/or retraining, an evaluation block 634 for evaluating a trained model (e.g., or retrained model), a decision block 638 for deciding whether a model score is improved compared to a prior model (e.g., prior version, etc.), a registration block 642 for registering the trained model if the model score is improved, a decision block 646 for deciding to update a model as deployed in the field with the trained model, a download block 650 for downloading the trained model to a builder, a build block 654 for building an image of the model (e.g., and/or model framework components, etc.), a deployment block for deploying the image on a container instance, an integration quality control or quality assessment block 662 to assess quality of the containerized image, a decision block 666 for deciding whether the quality is acceptable of the containerized image (e.g., optionally using a HITL approach) and a deployment block 670 for deploying the quality controlled/quality assessed containerized image to one or more edge devices.

In the example of FIG. 6, the method 600 may utilize a HITL approach. For example, the blocks 610 and 614 may be associated with human involvement and the decision block 666 may be associated with human involvement, which may include one or more humans in common with the blocks 610 and 614. For example, an expert may assess a model issue and then assess a new model that aims to resolve or otherwise address the model issue. As an example, a time delay between the blocks 614 and 666 may be of the order of hours or less. For example, a system pipeline can expeditiously utilize cloud-based resources to reduce delay between the blocks 614 and 666 such that an expert can remain focused on a particular model and a new model that can replace that model. As to the block 614, it can involve data identification, labeling, relabeling, etc., which may be associated with one or more data channels of field data from one or more sites. As an example, the blocks 614 and 666 may be associated with a web interface where, for example, a human can logon and perform one or more actions.

In the example of FIG. 6, the decision blocks 618, 626, 638, 646 and 666 are shown with “yes” branches (“Y”). Such decisions blocks can include no branches and/or other branches, which may direct the method 600 to one or more appropriate actions (e.g., terminate, wait, return, etc.).

In the example of FIG. 6, each block may be a workflow component and may correspond to a programmatic encapsulation of analysis techniques that otherwise, without automation, are performed manually by SMEs, data scientists, and data engineers.

As an example, a system can include a model monitoring pipeline that reads a SME relabeled dataset and data channels from an edge device and identifies if model performance is degraded. For example, a model score can worsen as instances of predicted class, being different from the actual SME labeled class, increases. Once a model performance score is below a user defined threshold(s), such a pipeline can update a model training dataset. As explained, a behavior may be a type of class. In various examples, a behavior may be addressed through one or more control actions that can be initiated locally and/or remotely for action in the field (e.g., control of field equipment). For example, consider an approach that can utilize one or more models to identify a behavior (e.g., as a class) and then call for one or more control actions to address the behavior. In such an example, a response to the one or more control actions may be determined through further acquisition of field data and assessment of the field data through use of the one or more models. In such an example, a determination may be made as to whether the one or more control actions adequately addressed the identified behavior. For example, whether new field data post control action, as input to the one or more models, results in identification of that behavior or not.

As an example, a system can include a model retraining pipeline that can monitor updates on a model training dataset. Such a pipeline can include features for training a model (e.g., model retrained with an updated dataset); evaluating a trained model (e.g., matrices such as F1 score, and accuracy may be utilized to quantify model performance where such scores may be compared with a previously saved model); saving a trained model (e.g., new model, etc.) where the trained model can be saved with details of a dataset it was trained on and one or more matrices, etc.

As an example, a system can include a release pipeline that checks for availability of new model versions. For example, consider a release pipeline that can create an image with a new model, deploy/run the image, test the image (e.g., according to a predefined set of tests to ensure the model is working as expected where results may be automatically notified to an SME), and approve the test results, for example, by SME approval (e.g., where an SME can take informed decision about to push the new model to one or more edge devices. In such an example, the release pipeline can include features to push a new model to an edge device or edge devices, for example, with appropriate security, addresses, instructions, etc.

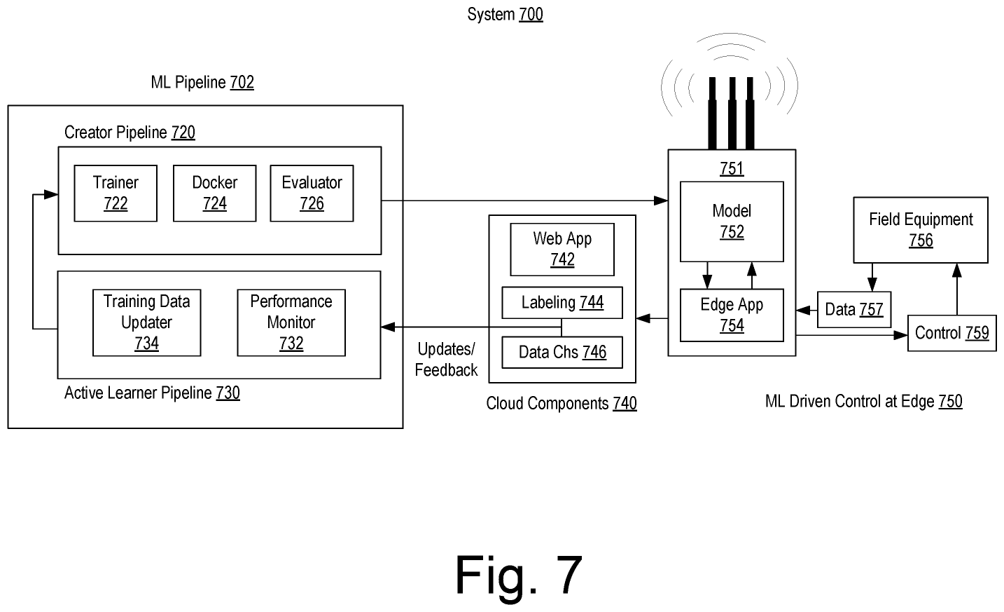

FIG. 7 shows an example of a system 700 that includes a ML pipeline 702, a creator pipeline 720, an active learner pipeline 730, cloud-based components 740 and ML driven control at the edge components 750.

The creator pipeline can include a trainer 722, a docker 724 and an evaluator 726 along with features to push a model to one or more edge devices 751 where a received model 752 can be containerized as an image and operable with an edge app 754, for example, using one or more APIs. As shown, the device 751 can receive data 757 from field equipment 756, which may be controlled via control instructions 759 as generated and issued by the device 751. The device 751 can transmit information to the one or more cloud-based components 740, which can include a web app 742, labeling/relabeling 744 and data channels 746 components. Output thereof (e.g., feedback) can be directed to the active learning pipeline 730, which can include a performance monitor 732 and a training data updater 734. As shown, updated training data can be utilized by the creator pipeline 720 in a cyclical manner for updating one or more models for use by one or more edge devices 751.

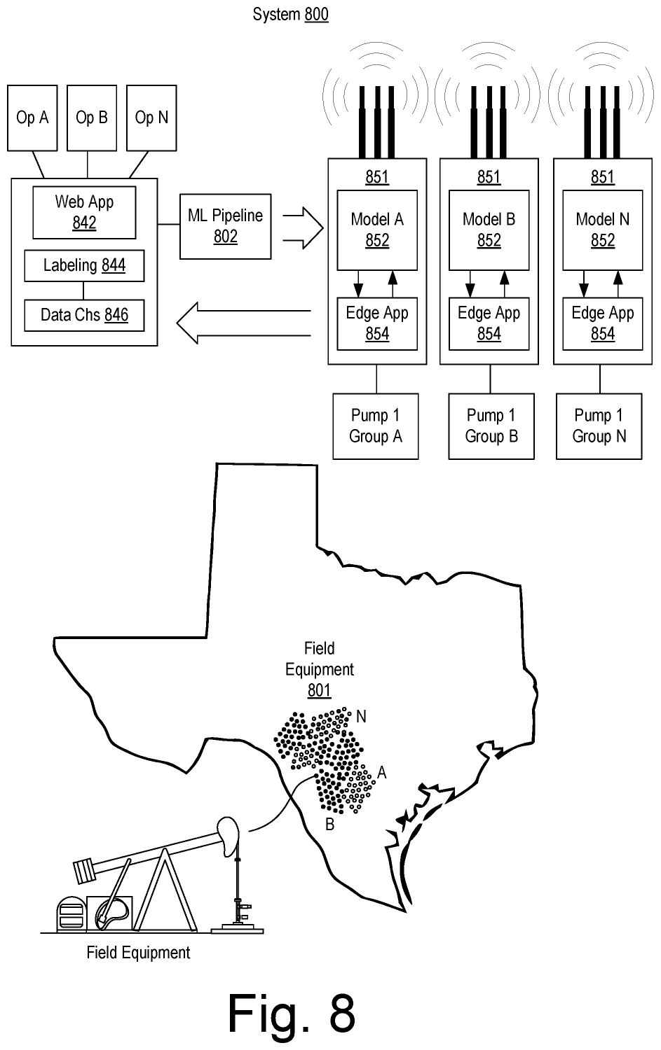

FIG. 8 shows an example of a system 800 that includes cloud-based components 842, 844 and 846 operatively coupled to a ML pipeline 802 for various edge devices 851, which can include different models A, B and N, as also labeled with reference numeral 852. As shown, each of the edge devices 851 can be associated with one or more pumps of a group of pumps (e.g., pump equipment) as in a field. In the example of FIG. 8, field equipment 801 is shown as associated with one or more fields in Texas, which may be associated with a basin and one or more reservoirs. As explained, hundreds or thousands of pieces of equipment may be installed where such equipment may be associated with different entities that have different manners of handling operations. As such, each entity may desire a different type of model, for example, for different descriptions of behaviors and/or conditions. In such an example, data may be proprietary such that data from one group is not to be disclosed to another group.

As an example, the system 800 may be replicated on a group-by-group basis and/or may include features for handling data security and differences between groups. As an example, a system may include a data anonymizer such that data are cleansed of identifying information for purposes of consideration as training data. For example, consider building a model that can be generic for different groups where classifications and/or predictions may differ for the different groups through use of one or more filters, etc. In such an example, the filters may be proprietary such that different groups are unaware of pre-output and other filters that may be utilized by one or more groups. As mentioned, edge devices may implement control where, for example, control may be specific to a group. For example, consider control being implemented at least in part via a customized edge app. As an example, models may be generic for different groups while edge apps are customized.

As an example, in FIG. 8, the system 800 may be utilized by one or more entities where, for example, each entity may have its own operational procedure. For example, consider an entity that supplies its own subject matter expert (SME) for one or more tasks. As an example, an entity may provide scheduling information such that the system 800 operates according to a schedule. As an example, in FIG. 8, the groups (A, B and C) may be groups of different entities. As an example, backend components can be managed by a single entity such that some tasks are performed by a single entity while other tasks are performed by multiple entities, which may be segregated by security mechanisms, etc. (e.g., to assure one entity does not access information of another entity).

As an example, a system may be utilized for one or more regions. As explained, a region in Texas may implement a system. The system 800 may be suitable for use in the Williston Basin in North Dakota, where thousands of rod life pumps are installed. As mentioned, a system can include models for classifying surface and downhole cards of rod lift pumps using machine learning to trigger mitigation and optimization workflows on the edge. As an example, ML model performance evaluations can be performed on an hourly basis. In such an example, a system can provide considerable time savings by reducing demands as to a manual iterative and repetitive process of monitoring and retraining one or more ML model.

As an example, an autoencoder ML model may be utilized that includes an encoder portion and a decoder portion. An autoencoder ML model can be described where the encoder portion maps input into code and where the decoder portion that maps the code to a reconstruction of the input. An autoencoder ML model can be a feedforward, non-recurrent neural network (e.g., akin to single layer perceptrons) that participate in multilayer perceptrons (MLP), for example, employing an input layer and an output layer connected by one or more hidden layers. An output layer can include the same number of nodes (neurons) as the input layer. As explained, an autoencoder ML model can reconstruct its inputs (e.g., by minimizing the difference between the input and the output) instead of predicting a target value Y given inputs X. As an example, an autoencoders ML model can be trained using unsupervised learning. As explained, data can be acquired and processed such that the data represent normal behavior of a pump (e.g., a pump system) where, once available, a ML model may be trained using such processed data in an unsupervised manner.

As explained, a system can be local such as an edge device system that can run in real-time with one or more edge application calculations to make classifications, predictions, etc., which may be for multiple days in the future. Such a system can provide accurate assessments of expectations of equipment. As an example, a system may be deployed on-premises and/or on the cloud (e.g., as a SaaS product, etc.).

As an example, a system can utilize complex ML techniques that do not necessarily demand the presence of an identifiable, consistent precursor. As an example, a system can be lightweight (e.g., an IoT or edge device) with a quick response time.

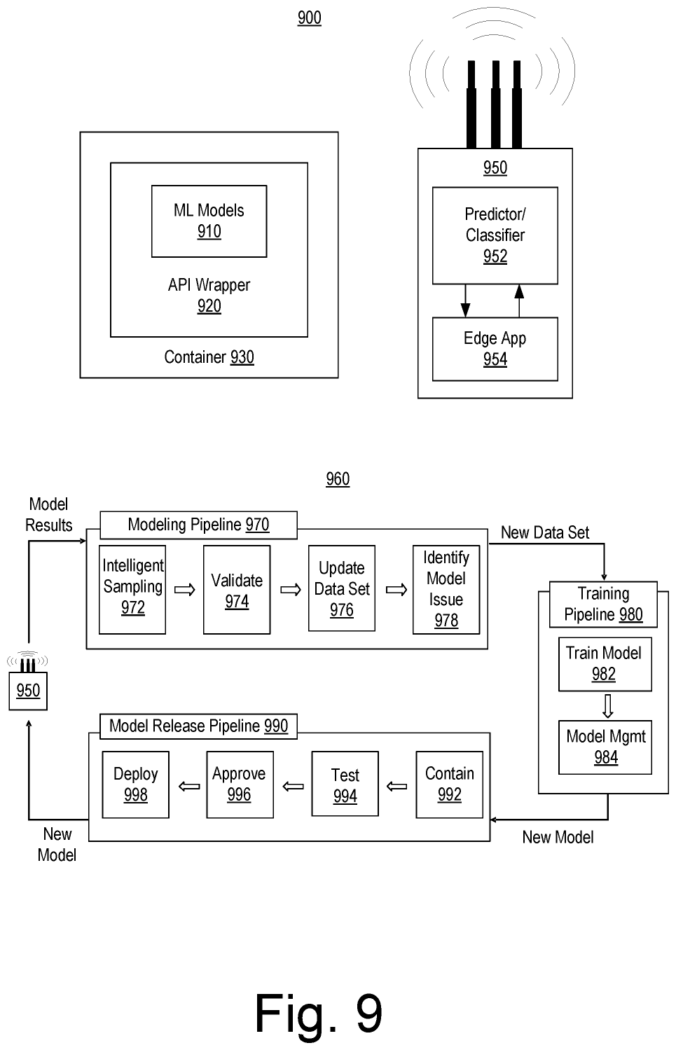

FIG. 9 shows an example of a system 900 that can include one or more containerized ML models 910 hosted within an application programming interface (API) wrapper 920 within a container 930. In such an example, the containerized ML models 910 can be deployed in the field, for example, using an edge computing device 950 with a predictor and/or classifier 952 and edge application 954 components. In such an example, the edge application component 954 can provide for processing of data such that the data or data derived therefrom are in a form suitable for ingestion by the predictor and/or classifier 952 (e.g., appropriate ML model inputs, etc.).

As shown in FIG. 9, the one or more ML models 910 can be utilized in a workflow 960 with the edge computing device 950. As shown, the workflow 960 can utilize one or more components, which may form various computational pipelines such as, for example, a modeling pipeline 970, a training pipeline 980 and a model release pipeline 990. In the example of FIG. 9, the modeling pipeline 970 can include an intelligent sampling component 972 for intelligent sampling of data and/or model results, a validation component 974 for validating results, an update component 976 for updating a data set and an identification component 978 for identifying one or more model issues, which can include, for example, model drift. In the example of FIG. 9, where a model issue is identified per the identification component 978, a new data set can be transmitted to the training pipeline 980.

As shown in the example of FIG. 9, the training pipeline 980 can include a train model component 982 and a model management component 984 where the train model component 982 can train (e.g., retrain, etc.) a model using at least a portion of the new data set, which may be an updated data set per the update component 976. As to the model management component 984, it can perform one or more model management tasks, which may be associated with an entity (e.g., a field operator, a field service provider, etc.). As an example, model management may include assessing one or more instances of a model and/or different models that may be implemented at one or more sites. For example, consider sites that have models that perform better than models at other sites, which may provide for assessing a model, selecting a model, adjusting training of a model, adjusting hyperparameters of a model, etc. While an arrow in the training pipeline 980 is shown as being downward, interactions may occur between the components 982 and 984 to provide for a new model that is trained at least in part using the new data set.

In the example of FIG. 9, the model release pipeline 990 can include a contain component 992 for containerizing the new model, a test component 994 for testing the new model in contrainerized form (e.g., ready for deployment and consumption by the edge computing device 950), an approval component 996 for approval of the new model per testing and a deploy component 998 for deploying the new, approved, tested and containerized model to the field. As shown, the deploy component 998 may transmit the model to the edge computing device 950 and/or to multiple edge computing devices (e.g., at one or more sites, etc.). In various examples, the workflow 960 may be primarily implemented for a particular field installation for particular field equipment where model results are based on data associated with that particular field equipment.

As an example, a container framework can provide for construction of a unit of software that packages up executable code and its dependencies such that an application can execute quickly and reliably from one computing environment to another. As an example, a container can be an image that is a lightweight, standalone, executable package of software that includes code, runtime, system tools, system libraries and settings. A container image becomes a “container” at runtime, for example, when run on a suitable engine (e.g., DOCKER engine for a DOCKER container image). As an example, an edge implementation may utilize a framework such as, for example, a lightweight machine learning framework such as the TENSORFLOW LITE (TFL) framework (GOOGLE LLC, Mountain View, California).

As an example, a model pipeline can be set up inside a container, wrapped around an ASGI based API technology to allow for real-time requests and responses (see, e.g., arrows in the edge computing device 950 of FIG. 9). As an example, signals can be received as expected by a ML model in real-time to produce as output. Such an approach allows for continuous monitoring and/or control and parallel computation on multiple edge devices.

As an example, a system, a method, etc., may utilize one or more machine learning features, which can be implemented using one or more machine learning models. As to types of machine learning models, consider one or more of a support vector machine (SVM) model, a k-nearest neighbors (KNN) model, an ensemble classifier model, a neural network (NN) model, etc. As an example, a machine learning model can be a deep learning model (e.g., deep Boltzmann machine, deep belief network, convolutional neural network, stacked auto-encoder, etc.), an ensemble model (e.g., random forest, gradient boosting machine, bootstrapped aggregation, AdaBoost, stacked generalization, gradient boosted regression tree, etc.), a neural network model (e.g., radial basis function network, perceptron, back-propagation, Hopfield network, etc.), a regularization model (e.g., ridge regression, least absolute shrinkage and selection operator, elastic net, least angle regression), a rule system model (e.g., cubist, one rule, zero rule, repeated incremental pruning to produce error reduction), a regression model (e.g., linear regression, ordinary least squares regression, stepwise regression, multivariate adaptive regression splines, locally estimated scatterplot smoothing, logistic regression, etc.), a Bayesian model (e.g., naïve Bayes, average on-dependence estimators, Bayesian belief network, Gaussian naïve Bayes, multinomial naïve Bayes, Bayesian network), a decision tree model (e.g., classification and regression tree, iterative dichotomiser 3, C4.5, C5.0, chi-squared automatic interaction detection, decision stump, conditional decision tree, M5), a dimensionality reduction model (e.g., principal component analysis, partial least squares regression, Sammon mapping, multidimensional scaling, projection pursuit, principal component regression, partial least squares discriminant analysis, mixture discriminant analysis, quadratic discriminant analysis, regularized discriminant analysis, flexible discriminant analysis, linear discriminant analysis, etc.), an instance model (e.g., k-nearest neighbor, learning vector quantization, self-organizing map, locally weighted learning, etc.), a clustering model (e.g., k-means, k-medians, expectation maximization, hierarchical clustering, etc.), etc.

As an example, a machine model may be built using a computational framework with a library, a toolbox, etc., such as, for example, those of the MATLAB framework (MathWorks, Inc., Natick, Massachusetts). The MATLAB framework includes a toolbox that provides supervised and unsupervised machine learning algorithms, including support vector machines (SVMs), boosted and bagged decision trees, k-nearest neighbor (KNN), k-means, k-medoids, hierarchical clustering, Gaussian mixture models, and hidden Markov models. Another MATLAB framework toolbox is the Deep Learning Toolbox (DLT), which provides a framework for designing and implementing deep neural networks with algorithms, pretrained models, and apps. The DLT provides convolutional neural networks (ConvNets, CNNs) and long short-term memory (LSTM) networks to perform classification and regression on image, time-series, and text data. The DLT includes features to build network architectures such as generative adversarial networks (GANs) and Siamese networks using custom training loops, shared weights, and automatic differentiation. The DLT provides for model exchange various other frameworks.

As an example, a system may utilize one or more recurrent neural networks (RNNs). One type of RNN is referred to as long short-term memory (LSTM), which can be a unit or component (e.g., of one or more units) that can be in a layer or layers. A LSTM component can be a type of artificial neural network (ANN) designed to recognize patterns in sequences of data, such as time series data. When provided with time series data, LSTMs take time and sequence into account such that an LSTM can include a temporal dimension. For example, consider utilization of one or more RNNs for processing temporal data from one or more sources, optionally in combination with spatial data. Such an approach may recognize temporal patterns, which may be utilized for making predictions (e.g., as to a pattern or patterns for future times, etc.).

As an example, the TENSORFLOW framework (Google LLC, Mountain View, CA) may be implemented, which is an open-source software library for dataflow programming that includes a symbolic math library, which can be implemented for machine learning applications that can include neural networks. As an example, the CAFFE framework may be implemented, which is a DL framework developed by Berkeley AI Research (BAIR) (University of California, Berkeley, California). As another example, consider the SCIKIT platform (e.g., scikit-learn), which utilizes the PYTHON programming language. As an example, a framework such as the APOLLO AI framework may be utilized (APOLLO.AI GmbH, Germany). As an example, a framework such as the PYTORCH framework may be utilized (Facebook AI Research Lab (FAIR), Facebook, Inc., Menlo Park, California).

As an example, a training method can include various actions that can operate on a dataset to train a ML model. As an example, a dataset can be split into training data and test data where test data can provide for evaluation. A method can include cross-validation of parameters and best parameters, which can be provided for model training.

The TENSORFLOW framework can run on multiple CPUs and GPUs (with optional CUDA (NVIDIA Corp., Santa Clara, California) and SYCL (The Khronos Group Inc., Beaverton, Oregon) extensions for general-purpose computing on graphics processing units (GPUs)). TENSORFLOW is available on 64-bit LINUX, MACOS (Apple Inc., Cupertino, California), WINDOWS (Microsoft Corp., Redmond, Washington), and mobile computing platforms including ANDROID (Google LLC, Mountain View, California) and IOS (Apple Inc.) operating system based platforms.

TENSORFLOW computations can be expressed as stateful dataflow graphs; noting that the name TENSORFLOW derives from the operations that such neural networks perform on multidimensional data arrays. Such arrays can be referred to as “tensors”.

As an example, a device and/or distributed devices may utilize TENSORFLOW LITE (TFL) or another type of lightweight framework. TFL is a set of tools that enables on-device machine learning where models may run on mobile, embedded, and IoT devices. TFL is optimized for on-device machine learning, by addressing latency (no round-trip to a server), privacy (no personal data leaves the device), connectivity (Internet connectivity is demanded), size (reduced model and binary size) and power consumption (e.g., efficient inference and a lack of network connections). Multiple platform support, covering ANDROID and iOS devices, embedded LINUX, and microcontrollers. Diverse language support, which includes JAVA, SWIFT, Objective-C, C++, and PYTHON. High performance, with hardware acceleration and model optimization. Machine learning tasks may include, for example, data processing, image classification, object detection, pose estimation, question answering, text classification, etc., on multiple platforms. As an example, the system 500 of FIG. 5 may utilize one or more features of the TFL framework.

As explained, machine Learning operations can demand incremental updates to account for model drift, improve PIs and enhance robustness of an overall solution, for example, as may be subject to additional data availability. Such operations tend to be iterative and involve additional repetitive efforts from data scientists. As explained, an automated framework can perform various tasks and can expedite involvement of one or more humans, as appropriate or desired. As an example, a MLOps framework can be flexible, repeatable and generalized for adoption in or conversion of manual end-to-end machine learning applications specific to IIOT devices.

As explained, a MLOps framework can automatically monitor ML model performance on various IIOT devices and identifies model drift due to differences, for example, in training and inference data. A framework can automatically trigger model retraining, for example, based on a configured threshold (e.g., number of re-classified images or introduction of a new class). A framework can track model versions and artifacts and automatically build, test and deploy a new trained model on one or more field devices (e.g., IIOT devices).

As explained, real-time pump data such as load and position can be received at an appropriate frequency. A ML model deployed on edge devices can perform classification and/or prediction on such data. Results may be automatically pushed into a cloud application where a machine and/or a human can assess the results from the ML model, validate and make adjustments when appropriate. As an example, a MLOps pipeline can automatically monitor data channels from edge devices and, for example, SME relabeled data and identify model drift. A MLOps pipeline can automatically update a training dataset with the latest available data and can trigger model training/retraining, for example, if model drift surpasses a pre-configured threshold.

As explained, once a new model is trained (e.g., retrained, etc.), a MLOps pipeline can capture artifacts such as confusion matrixes, accuracy score and F1 scores, etc. A pipeline can package the new model into a container, deploy it on a container instance and run pre-configured integration tests to ensure the new model is working as expected. Results of such a validation process can automatically be transmitted, for example, for machine and/or human an informed decision making (e.g., as to whether to push the new model to one or more edge devices) for site implementation.

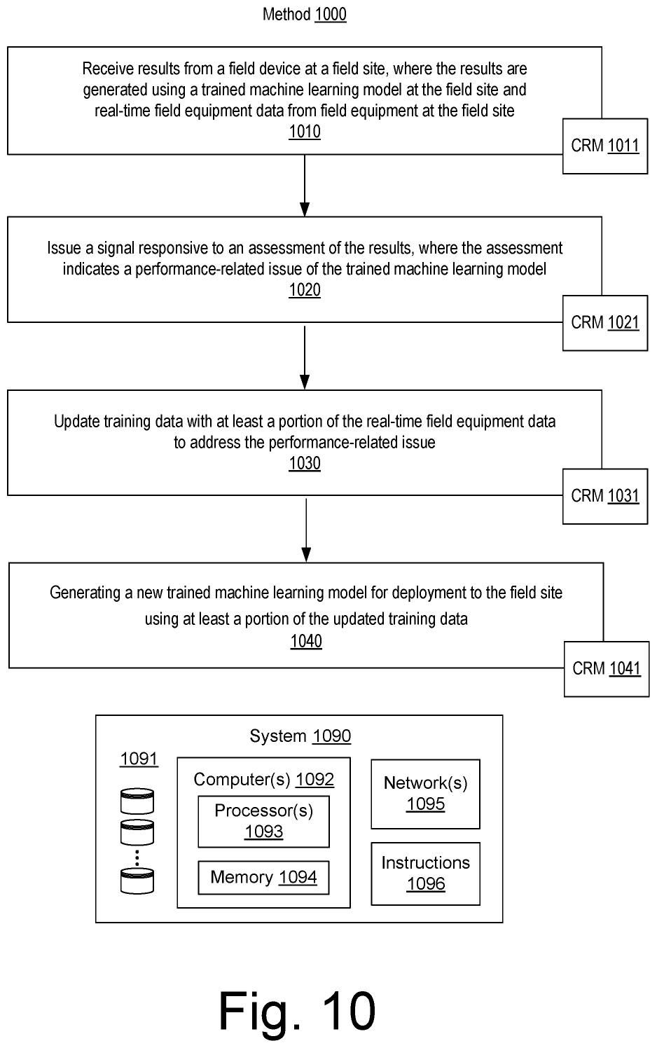

FIG. 10 shows an example of a method 1000 and an example of a system 1090. As shown, the method 1000 can include a reception block 1010 for receiving results from a field device at a field site, where the results are generated using a trained machine learning model at the field site and real-time field equipment data from field equipment at the field site; an issuance block 1020 for issuing a signal responsive to an assessment of the results, where the signal indicates a performance-related issue of the trained machine learning model; an update block 1030 for updating training data with at least a portion of the real-time field equipment data to address the performance-related issue; and a generation block 1040 for generating a new trained machine learning model for deployment to the field site using at least a portion of the updated training data.

The method 1000 is shown in FIG. 10 in association with various computer-readable media (CRM) blocks 1011, 1021 and 1031. Such blocks generally include instructions suitable for execution by one or more processors (or processor cores) to instruct a computing device or system to perform one or more actions. While various blocks are shown, a single medium may be configured with instructions to allow for, at least in part, performance of various actions of the method 1000. As an example, a computer-readable medium (CRM) may be a computer-readable storage medium that is non-transitory and that is not a carrier wave. As an example, one or more of the blocks 1011, 1021 and 1031 may be in the form processor-executable instructions.

In the example of FIG. 10, the system 1090, which may be a wellsite system, can include one or more information storage devices 1091, one or more computers 1092, one or more networks 1095 and instructions 1096. As to the one or more computers 1092, each computer may include one or more processors (e.g., or processing cores) 1093 and memory 1094 for storing the instructions 1096, for example, executable by at least one of the one or more processors 1093 (see, e.g., the blocks 1011, 1021 and 1031). As an example, a computer may include one or more network interfaces (e.g., wired or wireless), one or more graphics cards, a display interface (e.g., wired or wireless), etc.

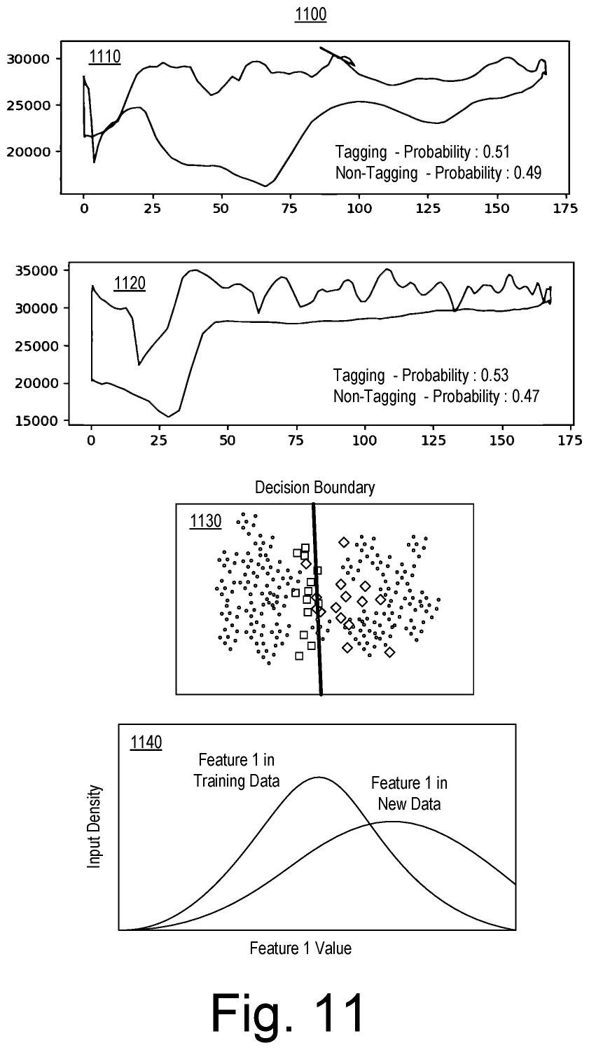

FIG. 11 shows an example of a method 1100 that can provide for decision making as to updating of one or more models. As an example, the method 1100 may be implemented as part of a model monitoring pipeline such as, for example, the model monitoring pipeline 970 of FIG. 9. As shown, the method 1100 can include receiving data from field operations where the data can be subjected to a sampling process, which can be automated. For example, consider data in plots 1110 and 1120 as may be real-time high frequency data from the field. As shown, an intelligent, automated sampling process can determine tagging probabilities and non-tagging probabilities for the data in the plots 1110 and 1120, which can differ for the data, for example, due in part to physical changes in the field as to one or more field operations (see, e.g., the data indicative of tag behavior 456 of FIG. 4). In the example of FIG. 11, the probabilities in the plots 1110 and 1120 may be output (e.g., model inferences, etc.) from a current model operating on field data. As an example, data can be assessed with respect to a decision boundary, for example, a boundary that is part of a model-based decision as to whether data are indicative of one type of behavior or another type of behavior in the field (e.g., tagging or non-tagging). In such an approach, a model may be assessed and optionally improved where data exist that may be new data from the field that have an impact in how model-based decisions are made. For example, in a plot 1130, a decision boundary is shown with respect to various data points where some of the data points may be selected with respect to the decision boundary as being closer to the decision boundary (e.g., as to tagging or non-tagging, etc.). Such data points, or samples, may be utilized for purposes of updating a model to improve model-based decision making for dynamic data in a field environment where changes (e.g., drift, etc.) may be expected. In particular, a model can be updated such that drift in the field can be appropriately tracked for model-based decision making. As an example, so-called “model drift” may indicate a scenario where a model no longer adequately represents what is happening in the field (e.g., as to decision making). Hence, where drift occurs, field data can be acquired and assessed for purposes of updating one or more models.

As shown in the example of FIG. 11, the method 1100 can include implementing automated drift monitoring, as indicated in a plot 1140 (see, e.g., the identification block 978 of FIG. 9). For example, the method 1100 can call for labeling of new data (e.g., manually, semi-automatically, and/or automatically) where a new labeled data set is generated. As explained, the new labeled data set may be based on intelligent data sampling such that the amount of new data to be labeled is reduced, focused, optimized, etc. As an example, an intelligent data sampling process may consider data from one or more sites, types of equipment, types of operations, etc. In such an example, certain types of data, issues, sites, etc., may be weighted to make intelligent decisions.

While the example of FIG. 11 shows data in the plots 1110 and 1120 that are assessed for tagging and/or non-tagging behaviors for sucker rod pumps, one or more other behaviors may be assessed for sucker rod pumps; noting that the method 1100 of FIG. 11 may be implemented for one or more other types of equipment, where field data can be assessed along with model performance to determine whether model drift and/or one or more other types of model issues may exist.

As an example, intelligent sampling can include implementation of one or more ML models, which may provide for a relatively broad assessment of various installations to improve sampling and thereby improve efficiency of a system. Intelligent sampling may also provide for decisions as to model commonalities where, for example, hyperparameters of certain models may be updated. In such an example, intelligent sampling techniques can provide for model improvements, for example, by providing feedback to model training, retraining, management, etc.

As an example, where a human is involved in labeling, such an approach can reduce demands on human time. For example, where data proximate to a decision boundary are identified for labeling, while other data excluded, the amount of data to be labeled can be reduced with some assurances of relevance as to model improvement (e.g., model updating). Referring to the plot 1140, as shown, input density versus feature value can be plotted for a particular feature, referred to as “feature 1”. In such an approach, if a shift in the distribution of training data (e.g., prior data) and new data occurs, then a decision can be made to update a training data set for retraining of one or more models. In such an example, a metric or metrics may be utilized for deciding whether or not an update is warranted. For example, consider a drift score that can be computed as a metric of each of the distributions or as a comparison of the two distributions (e.g., a difference in input density, feature value, etc.), which may then be compared to a threshold value or threshold values. In such an approach, depending on the comparison, where drift is beyond a threshold, updating can be called for, which can then proceed to update training data for performing retraining of one or more models. In the example of FIG. 11, as to tagging, which is given as an example, a model can be updated that provides for more accurate determinations as to tagging and/or non-tagging behaviors (e.g., via an improved decision boundary, etc.).

Referring to the method 600 of FIG. 6, the method 600 includes a drift block 618 as a decision block with a “yes” branch. As an example, the method 600 can include performing one or more actions of the method 1100 of FIG. 11, which may provide for making a decision as to whether or not to proceed to the update training block 622 of the method 600 of FIG. 6. As explained, one or more automated processes may be implemented, which may act to identify particular scenarios, particular data, etc., to expedite updating and/or reduce demand for updating. As explained, where a human is in the loop (HITL), one or more automated processes can help reduce demands on the HITL. Such an approach can help to automatically focus on data that may have the greatest impact on decision making as to updating and/or as to updating of one or more models (e.g., consider identification of particular data that may be relevant to decision making, close to a decision boundary, etc.).

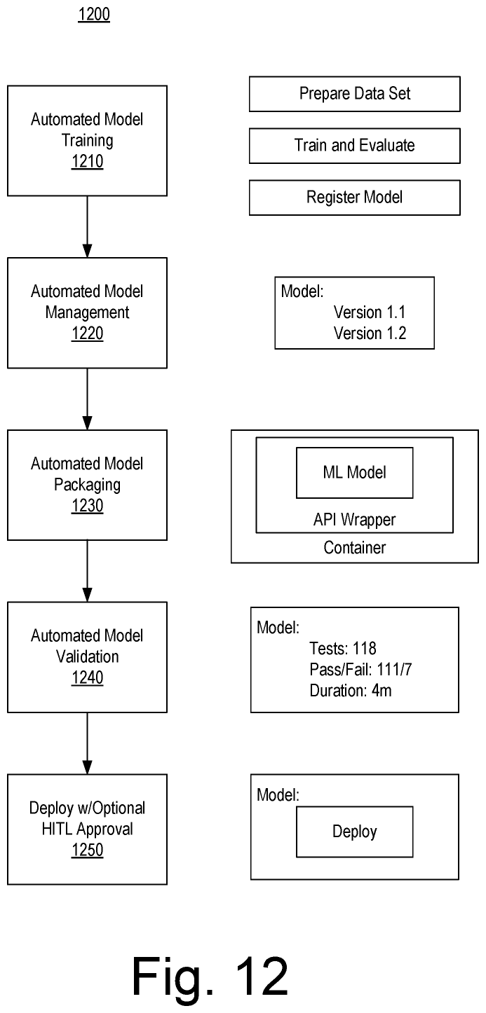

FIG. 12 shows an example of a method 1200 that can include an automated model training block 1210 for tasks such as data set preparation, training and evaluating and registering a model; an automated model management block 1220 for tasks such as versioning and storage of a registered model; an automated model packaging block 1230 for automatically packaging a model such as a ML model with an API wrapper within a container; an automated model validation block 1240 for automatically validating a model by running tests and checking run duration for suitable timings in real-time scenarios; and a deployment block 1250, which may operate optionally with HITL approval. For example, consider a GUI that can be rendered to a display to show various aspects of a model and its associated history (e.g., type, version, performance, etc.), where a deployment graphical control can be actuated for deployment of the model. While various blocks of the method 1200 are indicated to be automated, one or more blocks may optionally involve a HITL, which may be initiated according to a flag, a notification, etc. For example, a block may include limits, criteria, etc., for maintaining automated operation where a violation thereof may result in issuing a notification to a machine accessible to a human for human intervention.

As an example, a system can provide for segregation of tasks. For example, a system can provide for utilization with different entities, which may consider their data as proprietary. For example, consider subject matter experts (SMEs) that are entity specific for handling data, managing data, assessing labels, labeling of data, etc. In such an approach, the system may be operated by another entity that can handle modeling such as, for example, model building, model hyperparameter tuning, etc. As an example, a system can provide for an ecosystem where certain tasks are common to a number of entities and where other tasks can be performed by one or more individuals of another entity that runs the system to provide service to the number of entities.

A method can include receiving results from a field device at a field site, where the results are generated using a trained machine learning model at the field site and real-time field equipment data from field equipment at the field site; issuing a signal responsive to an assessment of the results, where the signal indicates a performance-related issue of the trained machine learning model; updating training data with at least a portion of the real-time field equipment data to address the performance-related issue; and generating a new trained machine learning model for deployment to the field site using at least a portion of the updated training data. In such an example, the method can include deploying the new trained machine learning model to the field site, which may provide for monitoring and/or control of the field equipment.

As an example, a method can include generating a containerized image of a new trained machine learning model for deployment to a field site.

As an example, a performance-related issue can include one or more of model classification drift and model prediction drift.

As an example, generating a new trained machine learning model can occur responsive to updating training data.

As an example, updating training data can include utilization of labels assigned to at least a portion of real-time field equipment data. For example, a new trained machine learning model can be generated using labels via supervised learning; noting that supervised and/or unsupervised learning may be utilized.

As an example, updating training data can occur responsive to issuance of a signal where the signal indicates a performance-related issue of a trained machine learning model.

As an example, a method can include evaluating a new trained machine learning model prior to building a containerized image of the new trained machine learning model.

As an example, a method can include building a containerized image of a new trained machine learning model and testing the containerized image. In such an example, the method can include, based on the testing, deciding to deploy the containerized image to the field site.

As an example, a method can include deploying a new trained machine learning model to at least one field site. For example, a method can include deploying such a model to multiple field sites as may be associated with a group or groups.

As an example, field equipment can include a pump and/or other equipment.

As an example, a trained machine learning model can process at least a portion of real-time field equipment data as image data. For example, consider image data that include dynacard images.

As an example, a method can include performing an assessment via a web application. For example, a web application can include features for assessing performance of a trained machine learning model and for assessing performance of a containerized image of a new trained machine learning model. In such an example, a method can include, responsive to a notification generated by the web application, deploying the containerized image of the new trained machine learning model to at least the field site.

As an example, a system can include a processor; memory accessible to the processor; and processor-executable instructions stored in the memory to instruct the system to: receive results from a field device at a field site, where the results are generated using a trained machine learning model at the field site and real-time field equipment data from field equipment at the field site; issue a signal responsive to an assessment of the results, where the signal indicates a performance-related issue of the trained machine learning model; update training data with at least a portion of the real-time field equipment data to address the performance-related issue; and generate a new trained machine learning model for deployment to the field site using at least a portion of the updated training data.

As an example, one or more computer-readable storage media can include processor-executable instructions to instruct a computing system to: receive results from a field device at a field site, where the results are generated using a trained machine learning model at the field site and real-time field equipment data from field equipment at the field site; issue a signal responsive to an assessment of the results, where the signal indicates a performance-related issue of the trained machine learning model; update training data with at least a portion of the real-time field equipment data to address the performance-related issue; and generate a new trained machine learning model for deployment to the field site using at least a portion of the updated training data.

As an example, a computer program product can include one or more computer-readable storage media that can include processor-executable instructions to instruct a computing system to perform one or more methods and/or one or more portions of a method. Various example methods may be performed in various combinations.

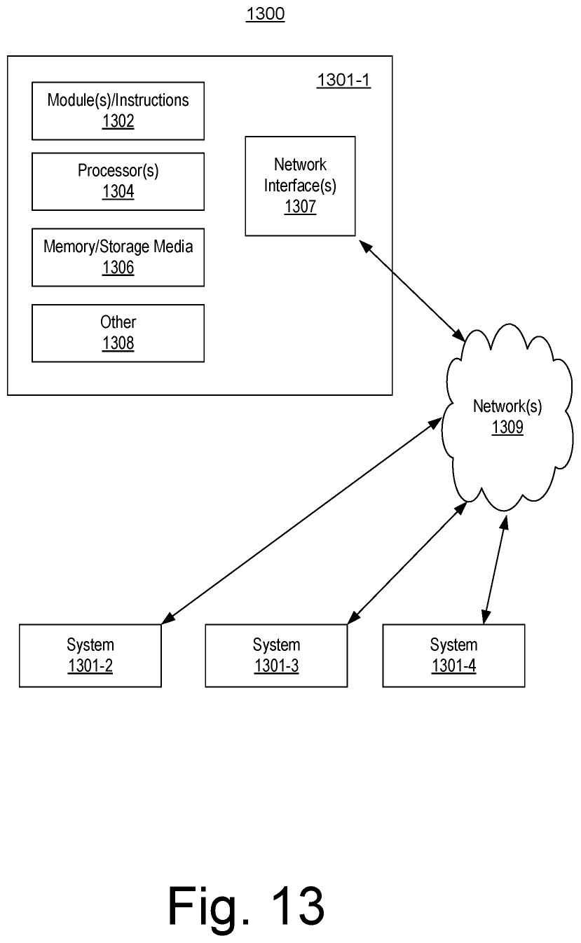

In some embodiments, a method or methods may be executed by a computing system. FIG. 13 shows an example of a system 1300 that can include one or more computing systems 1301-1, 1301-2, 1301-3 and 1301-4, which may be operatively coupled via one or more networks 1309, which may include wired and/or wireless networks. The system 1300 can include one or more other components, for example, consider one or more other components 1308.

As an example, a system can include an individual computer system or an arrangement of distributed computer systems. In the example of FIG. 13, the computer system 1301-1 can include one or more modules 1302, which may be or include processor-executable instructions, for example, executable to perform various tasks (e.g., receiving information, requesting information, processing information, simulation, outputting information, etc.).

As an example, a module may be executed independently, or in coordination with, one or more processors 1304, which is (or are) operatively coupled to one or more storage media 1306 (e.g., via wire, wirelessly, etc.). As an example, one or more of the one or more processors 1304 can be operatively coupled to at least one of one or more network interface 1307. In such an example, the computer system 1301-1 can transmit and/or receive information, for example, via the one or more networks 1309 (e.g., consider one or more of the Internet, a private network, a cellular network, a satellite network, etc.).

As an example, the computer system 1301-1 may receive from and/or transmit information to one or more other devices, which may be or include, for example, one or more of the computer systems 1301-2, etc. A device may be located in a physical location that differs from that of the computer system 1301-1. As an example, a location may be, for example, a processing facility location, a data center location (e.g., server farm, etc.), a rig location, a wellsite location, a downhole location, etc.

As an example, a processor may be or include a microprocessor, microcontroller, processor module or subsystem, programmable integrated circuit, programmable gate array, or another control or computing device.

As an example, the storage media 1306 may be implemented as one or more computer-readable or machine-readable storage media. As an example, storage may be distributed within and/or across multiple internal and/or external enclosures of a computing system and/or additional computing systems.

As an example, a storage medium or storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY disks, or other types of optical storage, or other types of storage devices.

As an example, a storage medium or media may be located in a machine running machine-readable instructions, or located at a remote site from which machine-readable instructions may be downloaded over a network for execution.

As an example, various components of a system such as, for example, a computer system, may be implemented in hardware, software, or a combination of both hardware and software (e.g., including firmware), including one or more signal processing and/or application specific integrated circuits.

As an example, a system may include a processing apparatus that may be or include a general-purpose processors or application specific chips (e.g., or chipsets), such as ASICs, FPGAs, PLDs, or other appropriate devices.

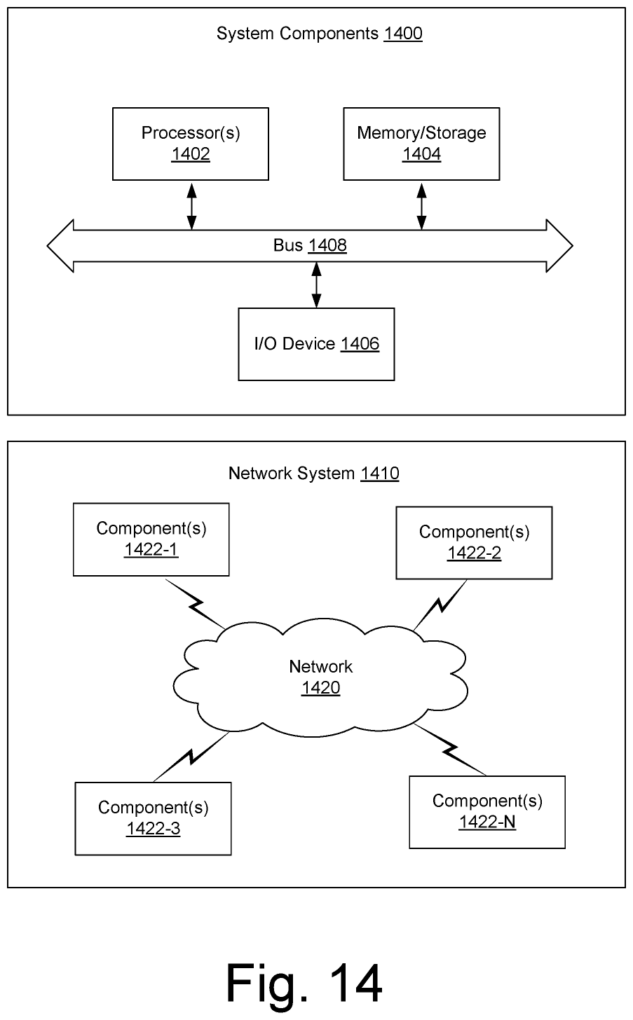

FIG. 14 shows components of an example of a computing system 1400 and an example of a networked system 1410 with a network 1420. The system 1400 includes one or more processors 1402, memory and/or storage components 1404, one or more input and/or output devices 1406 and a bus 1408. In an example embodiment, instructions may be stored in one or more computer-readable media (e.g., memory/storage components 1404). Such instructions may be read by one or more processors (e.g., the processor(s) 1402) via a communication bus (e.g., the bus 1408), which may be wired or wireless. The one or more processors may execute such instructions to implement (wholly or in part) one or more attributes (e.g., as part of a method). A user may view output from and interact with a process via an I/O device (e.g., the device 1406). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 1410. The network system 1410 includes components 1422-1, 1422-2, 1422-3, . . . 1422-N. For example, the components 1422-1 may include the processor(s) 1402 while the component(s) 1422-3 may include memory accessible by the processor(s) 1402. Further, the component(s) 1422-2 may include an I/O device for display and optionally interaction with a method. The network 1420 may be or include the Internet, an intranet, a cellular network, a satellite network, etc.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising:
receiving results from a field device at a field site, wherein the results are generated using a trained machine learning model at the field site and real-time field equipment data from field equipment at the field site;
issuing a signal responsive to an assessment of the results, wherein the signal indicates a performance-related issue of the trained machine learning model;
updating training data with at least a portion of the real-time field equipment data to address the performance-related issue; and
generating a new trained machine learning model for deployment to the field site using at least a portion of the updated training data.

2. The method of claim 1, comprising deploying the new trained machine learning model to the field site.

3. The method of claim 1, comprising generating a containerized image of the new trained machine learning model for deployment to the field site.

4. The method of claim 1, wherein the performance-related issue comprises one or more of model classification drift and model prediction drift.

5. The method of claim 1, wherein generating the new trained machine learning model occurs responsive to updating the training data.

6. The method of claim 1, wherein updating the training data comprises utilization of labels assigned to the at least a portion of the real-time field equipment data.

7. The method of claim 6, wherein the new trained machine learning model is generated using the labels via supervised learning.

8. The method of claim 1, wherein updating the training data occurs responsive to issuance of the signal.

9. The method of claim 1, comprising evaluating the new trained machine learning model prior to building a containerized image of the new trained machine learning model.

10. The method of claim 1, comprising building a containerized image of the new trained machine learning model and testing the containerized image.

11. The method of claim 10, comprising, based on the testing, deciding to deploy the containerized image to the field site.

12. The method of claim 1, comprising deploying the new trained machine learning model to the field site and at least one additional field site.

13. The method of claim 1, wherein the field equipment comprises a pump.

14. The method of claim 1, wherein the trained machine learning model processes at least a portion of the real-time field equipment data as image data.

15. The method of claim 14, wherein the image data comprise dynacard images.

16. The method of claim 1, comprising performing the assessment via a web application.

17. The method of claim 16, wherein the web application comprises features for assessing performance of the trained machine learning model and for assessing performance of a containerized image of the new trained machine learning model.

18. The method of claim 17, comprising, responsive to a notification generated by the web application, deploying the containerized image of the new trained machine learning model to at least the field site.

19. A system comprising:
a processor;
memory accessible to the processor; and
processor-executable instructions stored in the memory to instruct the system to:
receive results from a field device at a field site, wherein the results are generated using a trained machine learning model at the field site and real-time field equipment data from field equipment at the field site;
issue a signal responsive to an assessment of the results, wherein the signal indicates a performance-related issue of the trained machine learning model;
update training data with at least a portion of the real-time field equipment data to address the performance-related issue; and
generate a new trained machine learning model for deployment to the field site using at least a portion of the updated training data.

20. One or more computer-readable storage media comprising processor-executable instructions to instruct a wellsite computing system to:
receive results from a field device at a field site, wherein the results are generated using a trained machine learning model at the field site and real-time field equipment data from field equipment at the field site;
issue a signal responsive to an assessment of the results, wherein the signal indicates a performance-related issue of the trained machine learning model;
update training data with at least a portion of the real-time field equipment data to address the performance-related issue; and
generate a new trained machine learning model for deployment to the field site using at least a portion of the updated training data.
